(19) United States
(12) Patent Application Publication
(10) Pub. No.: US 2011/0004533 A1
(43) Pub. Date: Jan. 6, 2011

(54) VIRAL STORE APPLICATION

(75) Inventors: Santos Soto, San Francisco, CA (US); Marc Tenedora, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Jungle U LLC, San Francisco, CA (US)

(21) Appl. No.: 12/823,405

(22) Filed: Jun. 25, 2010

Related U.S. Application Data
(60) Provisional application No. 61/220,972, filed on Jun. 26, 2009.
(60) Provisional application No. 61/220,973, filed on Jun. 26, 2009.

(51) Int. Cl. G06Q 30/00

(52) U.S. Cl. 705/27.1

(57) ABSTRACT

Embodiments of the invention provide systems and methods for distribution and promotion of one or more products through a Viral Store Application (VSA). According to one embodiment, a method of providing a Viral Store Application (VSA) can comprise receiving a request at a commerce management server, the request to create a new VSA on a system remote from the commerce management server. Links between the new VSA and product information for each of one or more products stored on one or more servers remote from the commerce management server can be defined. The links between the new VSA and the product information can be stored as a definition for the new VSA. A link to the definition for the new VSA can be inserted into a web page on the system remote from the commerce management server.

### CROSS-REFERENCES TO RELATED APPLICATIONS

The present application claims benefit under 35 USC 119(e) of U.S. Provisional Application No. 61/220,972, filed on Jun. 26, 2009 by Soto et al. and entitled “Viral Store Application,” and U.S. Provisional Application No. 61/220,973, filed on Jun. 26, 2009 by Soto et al. and entitled “Page Peel,” of which the entire disclosure of each is incorporated herein by reference for all purposes. The present application is also related to U.S. patent application Ser. No. ______ (Attorney Docket Number 028009-000310US, filed concurrently herewith by Soto et al. and entitled “Dialogue Advertising” which is also incorporated herein by reference in its entirety for all purposes.

### BACKGROUND

Embodiments of the present invention relate generally to methods and systems for e-commerce and more particularly to a Viral Store Application (VSA) for distributing and promoting one or more products in a web store.

There are many different ways on the Internet or on mobile applications to promote web sites, applications or products for sale. One well-known way, on the Internet, of promoting a web site or a product for sale is by using web advertisements. Web advertisements can come in many different forms, such as banner ads, pop-up ads, etc. Advertisements such as these can be integrated into a web site and then displayed to users that visit the web site using a web browser. The same can be said for advertising on mobile applications.

Another way that a web store or product can be promoted is through word of mouth. For example, word of mouth may include recommendations from friends, reviews written on websites, blogs, etc. Both of these types of promotion often use a typical web link to connect a user with the promoted web site or product. For example, a user may click on a link in a web banner ad to be transported to a promoted web site. Alternatively, the user may be given a URL that can be typed into the user's web browser. This method is also applied to mobile applications that link to a web page on a mobile device.

Web sites commonly attempt to attract as many users as possible to their web site, because a web site that attracts many users is more valuable to advertisers than a web site with little traffic. Since web advertisements often redirect users to other sites, web advertisements may be counterproductive to the purpose of collecting a maximum amount of web traffic.

Additionally, some web sites charge web advertisers for every user that clicks on a hosted advertisement. However, users are less likely to trust a web advertisement that will take them to an unfamiliar web site. As a result, this potential source of income for web sites is often not as high as it could potentially be.

Furthermore, a customer is less likely to purchase a product from web advertisements for an unfamiliar merchant. A customer is more likely to trust a merchant if the merchant has a personal recommendation from a known source (i.e. friends, peers, trusted blogs, etc.).

In consideration of the above, it would be desirable for a merchant to distribute a form of advertising that does not require a user to be redirected away from a web site that the user may be viewing. This would allow the hosting web site to keep traffic on their site. Additionally, it would be desirable to have a form advertising that allows users to receive the advertisement from a known source. Furthermore, it would be desirable to have a form of advertising that converted a higher percentage of users into consumers of the advertised product and allowed the host of the web advertisement to capture a portion of any sale completed through the hosted web advertisement.

### BRIEF SUMMARY

Embodiments of the invention provide systems and methods for distribution and promotion of one or more products through a Viral Store Application (VSA). According to one embodiment, a method of providing a Viral Store Application (VSA) can comprise receiving a request at a commerce management server, the request to create a new VSA on a system remote from the commerce management server. Links between the new VSA and product information for each of one or more products stored on one or more servers remote from the commerce management server can be defined. The links between the new VSA and the product information can be stored as a definition for the new VSA. A link to the definition for the new VSA can be inserted into a web page on the system remote from the commerce management server. For example, the web page on the system remote from the commerce management server can comprise a web page selected from a group consisting of, a social networking page, a blog page, personal web page, email, mobile device application. In some cases, inserting the link to the definition of the new VSA can comprise inserting a new element into the web page, the new element comprising an ad having a page peel effect for revealing the VSA.

In some cases, receiving the request to create the new VSA can comprise receiving a request to create a first generation VSA. In such cases, defining the links between the new VSA and the product information can comprise receiving a selection of the one or more products and creating the links to the product information for the selected products. Alternatively, receiving the request to create the new VSA can comprise receiving a request to create multi-generational VSA. In such cases, defining the links between the new VSA and the product information can comprise identifying a source VSA for the new VSA and copying at least one link to product information from the identified source VSA to a link in the new VSA.

The method can further comprise tracking creation of the new VSA. For example, tracking the creation of the new VSA can comprises determining whether the new VSA is a first generation VSA. In response to determining the new VSA is not a first generation VSA, a source VSA for the new VSA can be identified. A link between the source VSA and the new VSA can be identified. A record of the link between the source VSA and the new VSA can then be stored.

According to another embodiment, a commerce management server system can comprise a processor and a memory communicatively coupled with and readable by the processor. The memory can have stored therein a series of instructions which, when executed by the processor, cause the processor to provide a Viral Store Application (VSA) by receiving a request to create a new VSA on a system remote from the commerce management server. Links between the new VSA and product information for each of one or more products stored on one or more servers remote from the commerce management server can be defined. The links between the new VSA and the product information can be stored as a definition for the new VSA. A link to the definition for the new VSA can be inserted into a web page on the system remote from the commerce management server.

In some cases, receiving the request to create the new VSA can comprise receiving a request to create a first generation VSA. In such cases, defining the links between the new VSA and the product information can comprise receiving a selection of the one or more products and creating the links to the product information for the selected products. Alternatively, receiving the request to create the new VSA can comprise receiving a request to create multi-generational VSA. In such cases, defining the links between the new VSA and the product information can comprise identifying a source VSA for the new VSA and copying at least one link to product information from the identified source VSA to a link in the new VSA.

The commerce management server can also track creation of the new VSA. For example, tracking the creation of the new VSA can comprises determining whether the new VSA is a first generation VSA. In response to determining the new VSA is not a first generation VSA, a source VSA for the new VSA can be identified. A link between the source VSA and the new VSA can be identified. A record of the link between the source VSA and the new VSA can then be stored.

According to yet another embodiment, a machine-readable medium can have stored thereon a series of instructions which, when executed by a processor, cause the processor to for providing a Viral Store Application (VSA) by receiving a request to create a new VSA on a remote system. Links between the new VSA and product information for each of one or more products stored on one or more remote servers can be defined. The links between the new VSA and the product information can be stored as a definition for the new VSA. A link to the definition for the new VSA can be inserted into a web page on the remote system.

In some cases, receiving the request to create the new VSA can comprise receiving a request to create a first generation VSA. In such cases, defining the links between the new VSA and the product information can comprise receiving a selection of the one or more products and creating the links to the product information for the selected products. Alternatively, receiving the request to create the new VSA can comprise receiving a request to create multi-generational VSA. In such cases, defining the links between the new VSA and the product information can comprise identifying a source VSA for the new VSA and copying at least one link to product information from the identified source VSA to a link in the new VSA.

Creation of the new VSA can also be tracked. For example, tracking the creation of the new VSA can comprises determining whether the new VSA is a first generation VSA. In response to determining the new VSA is not a first generation VSA, a source VSA for the new VSA can be identified. A link between the source VSA and the new VSA can be identified. A record of the link between the source VSA and the new VSA can then be stored.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a flow chart showing the distribution capability of the Viral Store Application (VSA) according to various embodiments.

FIG. 4 is a flow chart showing an exemplary VSA order and transaction flow, if the Merchant handles product fulfillment, according to various embodiments.

FIG. 5 is a screenshot illustrating an exemplary user interface of a VSA Store, on the Internet, according to various embodiments.

FIG. 6 is a screenshot illustrating an exemplary user interface of a VSA Store, on the Internet, according to various embodiments.

FIG. 7A through 7K show are screenshots illustrating an exemplary user interface of a VSA Store, on the Internet, according to various embodiments.

FIG. 8 is a screenshot illustrating an exemplary user interface of a VSA, on the Internet, according to various embodiments.

FIG. 9 illustrate an animation movement of a page peel effect for an ad or other element, on the Internet, according to various embodiments.

FIG. 10 shows an example of the look of the page peel icon when the icon is initially loaded onto a web page, email, or mobile application according to various embodiments.

FIG. 11 shows the possible positioning of a page peel icon on a web page according to various embodiments.

FIG. 12 is a screenshot illustrating an exemplary user interface with an expanded page peel ad, on a web page, according to various embodiments.

FIG. 13 is block diagram showing various system components that can be used with a VSA system according to various embodiments.

FIG. 14 is a block diagram illustrating additional details of system components for creating and tracking VSAs according to one embodiment of the present invention.

FIG. 15 is a flowchart illustrating an exemplary process for defining a VSA according to one embodiment of the present invention.

FIG. 16 is a flowchart illustrating an exemplary process for multi-generational tracking VSAs according to one embodiment of the present invention.

FIG. 17 is a screenshot illustrating an exemplary user interface of a VSA store, as a mobile application, according to various embodiments.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the present invention are directed toward social networking e-commerce. More specifically, embodiments of the present invention are directed to an application, referred to herein as a Viral Store Application (VSA), that enhances the promotional distribution of a web store or product. A VSA can facilitate the management, promotion and sale of products. It allows merchants to gather transactions from customers on separate web pages, emails or cell phone text messages. Embodiments of the VSA may be distributed with product display tools, shopping options, secure checkout capabilities, universal shopping cart, product reviews, price comparison tools, in-store pickup capabilities, sharing tools and store front interfaces. The viral component of the VSA may also allow outside users to duplicate VSA Web Stores and install it on their personal web pages (e.g., Myspace, Facebook, Blogger, a personal web site, etc.). Users may then send emails or SMS messages announcing the VSA to their friends. Copies of the store can have the ability to spread across the Internet an infinite number of times. Orders made from the VSA can get sent back to the merchant. The transactions can be funneled down to a market site where the merchant created their original web store. If a VSA host takes part in the associate program, they may receive a cut from the profits made from their VSA location.

Another aspect of the VSA application may allow users to generate a “most wanted” list of products that the user wishes to receive as gifts. The most wanted list can then be turned into a VSA. The user can host the most wanted VSA list on a personal web page, such as a social networking site. The user may also distribute their VSA list as an email or SMS text message/notification. The user's friends can view the VSA and purchase the products for the user or take part in a collective payment contribution towards the products' purchase.

According to various embodiments, an application is disclosed that facilitates the management, promotion and sale of products on outside hosted platforms (i.e., web sites not owned or managed by the merchants of the products for sale) from a contained application. The application can take inventory information from a market site location and turn it into a web store that allows users to distribute products on their own personal web pages, emails, cell phones, or other means. Copies of the application can be managed and controlled from a single market site or mobile application. The market site can provide merchants with tools to manage their application. This application is often referred to as a VSA or VSA application.

According to various embodiments, a complete and secure shopping cart checkout is enabled within the VSA. A customer may browse products from a VSA application and add the products to a shopping cart within the VSA. Consumers then may have the ability to complete a secure credit card or other payment method transaction without leaving the web location hosting the VSA.

According to various embodiments, a shared shopping cart can be implemented that remembers the products added to the cart as the customer travels between the market site and VSAs hosted on other sites, emails or on a mobile application. The shared shopping cart can enable a customer to make one transaction while switching between web stores, VSAs on emails or mobile applications linked to the market site and VSA.

According to various embodiments, VSAs hosted on various sites communicate with merchants and fulfillment warehouses to maintain up-to-date inventory information. This helps allow orders and transactions to be made from a location other than the market site. When inventory is out of stock on the market site, the VSA location web store can display the product as “Out Of Stock.” When product inventory or product information is updated from the market site, the VSA location web store may be updated at the same time.

According to various embodiments, the revenue or profit generated from a VSA transaction is shared between the market site, merchant, VSA Host and, in some cases, the fulfillment warehouse. As an incentive to distribute the VSA on personal web pages, emails or cell phones, a VSA Host may take part in an associate program. The associate program allows a VSA Host to receive a cut of profits made from the sales gathered from their VSA location. The VSA application can send the transaction to the market site. Once the product is shown as delivered to the customer in good condition, the profits of that sale can be split between the market site, merchant, VSA Host, and, in some cases, the fulfillment warehouse.

According to various embodiments, a method of distributing the VSA application across the internet and across cell phones or other mobile devices is disclosed. Users are able to notify their friends of a VSA store open for business by email or text message. When the recipient opens the email or text message, they may receive an actual VSA application with the product that the user recommends. The recipient is able to make a complete purchase from their email or text message. If sent as a text message, the viewer cam linked to a VSA via their mobile browser or mobile application. If sent as an email, the user can complete a transaction if the email platform allows. If not allowed, then the user can be linked to the web page of the VSA location.

According to various embodiments, a VSA can be created from a most wanted list. Users can go to the market site, located on the Internet or mobile application, and choose their favorite products to put into a list connected to their market site account. From their list of Most Wanted Products, the user can create a VSA with the chosen products. The user may then distribute the VSA most wanted list by hosting it on their personal web pages or sending it via email or text message. Friends of the user are able to view the most wanted list and purchase the products for the user. Once the product is purchased, it can be shipped to the user.

According to various embodiments, a collaborative payment option may allow a group of customers to contribute a portion of a payment towards a purchase. For example, if a user has a most wanted list VSA, the user's friends can contribute funds towards a specific product. Contributions can be made public or anonymously by announcements. Once the product has enough collective funds for payment, the credit cards may be charged and the product can be shipped to the user. However, it should be noted that payment is not limited to credit cards. Other payment types are also available. e.g., phone bill, bank transactions, 3^{rd} party payment systems such as Pay-Pal, etc.

According to various embodiments, a management tool is disclosed that allows the merchant to grant or deny use of their VSA or product on a VSA. Potential VSA hosts that wish to install a merchant's VSA on a URL can be registered with the merchant and the market site. Before the potential host is granted access to the embed code used to create a VSA, the host may be required to provide the exact URL address where the VSA may be installed. The URL can be listed inside the Merchant's VSA distribution list. If a merchant feels that they do not want to be associated with a specific URL, the merchant may disable the URL. As a result, the VSA may no longer be displayed at the disabled URL. Additionally or alternatively, specific products can also be disabled from being displayed at a URL. In addition, URLs can be blocked during the registration phase. The VSA application can be configured to not load inside a URL that is not registered by the merchant or market site.

According to various embodiments, a live chat customer support system can be used to help VSA users connect with a customer support correspondent provided by either the market site or merchant. Live chat customer support can be used to aid the user in any customer support issue related to the VSA or product. Various additional details of embodiments of the present invention will be described below with reference to the figures.

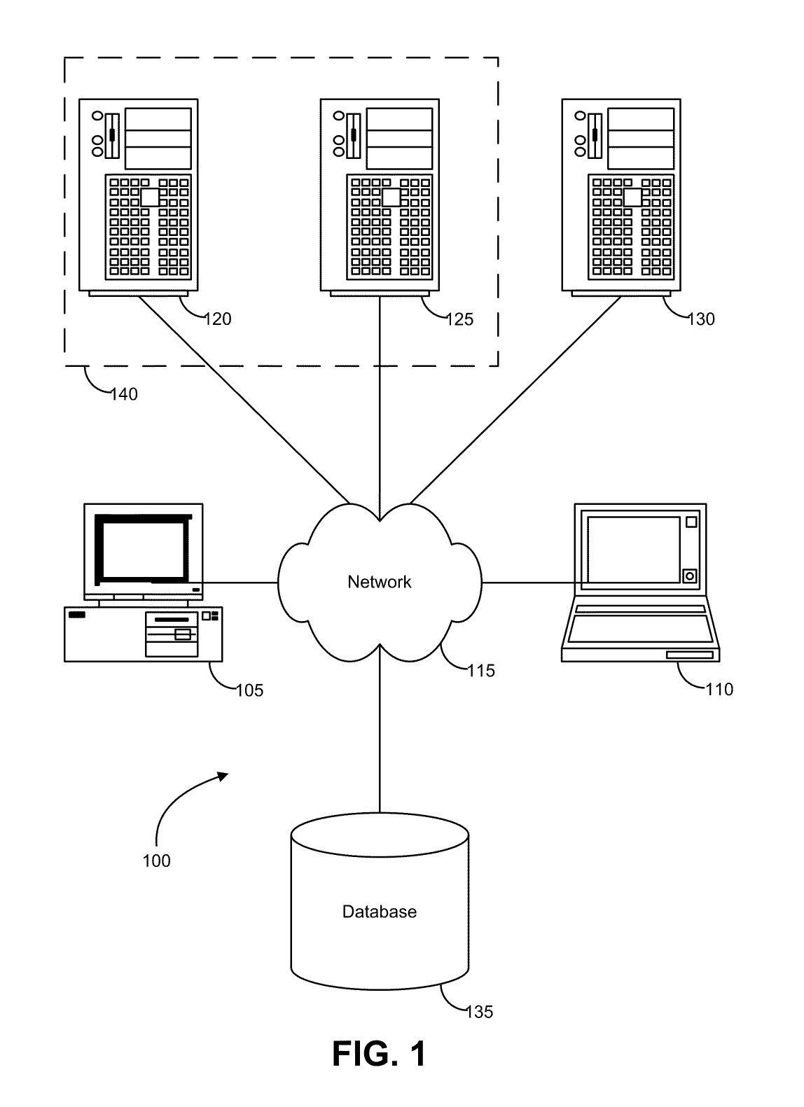

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

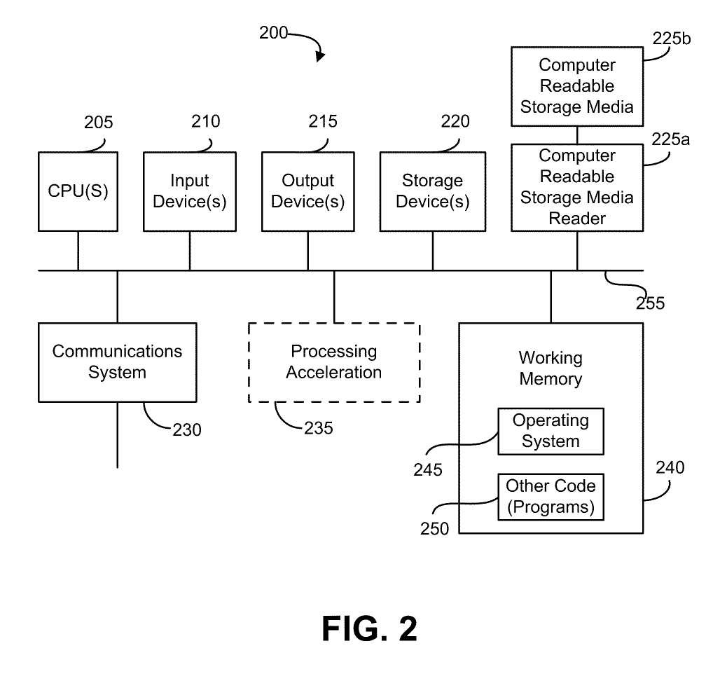

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

Embodiments of a Viral Store Application (VSA), formatted for web pages, social networking site applications, and mobile applications, will be described in detail below. At a high level, embodiments of VSAs enable a number of beneficial features for web hosts, merchants, market sites, and consumers. A VSA can be an embedded web store hosted on a web site. A VSA can allow a visitor of the web site to not only view the products advertised in the VSA, but also purchase the advertised items without having to leave the underlying web site. In other words, the user is able to interact with the advertisement while maintaining a session with the host site. Additionally, embodiments of VSAs allow the web host to select the merchandise that is advertised in the VSA. For example, a user of a social networking site may create a VSA with various items from different merchants and market sites that interest the user. When visitors to the user's social networking site make a purchase through the user's VSA, the user may receive a portion of the profit generated from the sale. Additionally, a user can virally distribute a created VSA so that other users can also advertise the items in the VSA in their own web sites, social network sites, or in other locations.

According to some embodiments, a VSA may comprise many different features enabled by various modules within a VSA. Such features may include a web store interface, a product information module, a universal shopping cart (includes payment systems and in-store pickup options), an associate program, customer support chat, product reviews, price comparison tools, and a viral distribution module.

A web store interface can provide a shop friendly environment for the user to browse through the merchant's products based on a store set up on the market site. From this interface, the user may also select product options (e.g., size, color, etc.) and add the item to their shopping cart.

A shopping cart may allow the user to make a secure order transaction through the VSA. The products that were added to their cart can be shown in the cart. In this section of the VSA, the user may specify the payment type, billing info, shipping info, contact info, and confirm their order. Once an order is placed, the order invoice can be sent to the merchant. All percentages from the profits can be automatically divided up between the merchant, market site, and, if the merchant allows the associate program, the VSA host may also be included into the profit distribution. In some cases, a fulfillment warehouse is also included in the cut of the profits. In addition to payment types, the user can choose to put a product on hold at a local retail store location through the use of in-store pickup.

Within the payment type page, of the shopping cart, the user may be allowed to select from different payment types to complete their order transaction. Payment types include but are not limited to credit card transaction, bank account transfer, phone bill, 3^{rd} party payment system (e.g., Pay-Pal), cash on delivery, mobile phone number, etc.

A credit card payment type allows the user to make a transaction with the use of credit or debit card. The user may provide their billing info, shipping info, contact info, and credit card info to make a complete transaction. Once such information is provided, the user can confirm their provided information to make a complete transaction. Once an order is placed, the order invoice can be sent to the merchants. Percentages from the profits can be automatically divided up between the merchants, market site, and, if the merchants allow the associate program, the VSA host may also be included into the profit distribution. In some cases, a fulfillment warehouse is also included in the cut of the profits.

A bank account transfer payment type allows the user to make a transaction with the use of bank account transfer. The user may provide their bank routing number, and bank account number to make a complete transaction. Once such information is provided, the user can confirm their provided information to make a complete transaction. Once an order is placed, the order invoice can be sent to the merchants. Percentages from the profits can be automatically divided up between the merchants, market site, and, if the merchants allow the associate program, the VSA host may also be included into the profit distribution. In some cases, a fulfillment warehouse is also included in the cut of the profits.

A phone bill payment type allows the user to make a transaction with the use of their mobile provider subscription. If the mobile provider allows this transaction to take place, the user may provide their mobile provider account number, billing info, shipping info, contact info and mobile phone number to make a complete transaction. Once such information is provided, the user can confirm their provided information to make a complete transaction. Once an order is placed, the order invoice can be sent to the merchants. Percentages from the profits can be automatically divided up between the merchants, market site, and, if the merchants allow the associate program, the VSA host may also be included into the profit distribution. In some cases, a fulfillment warehouse is also included in the cut of the profits.

A 3^{rd} party payment system type allows the user to make a transaction with the use of a 3^{rd} party payment system. The user may be required to log into their 3^{rd} party payment system account in order to make a complete transaction. Once logged in, the user may have to take additional steps, according to the 3^{rd} party payment system, to complete their transaction. Payment is received through the 3^{rd} party payment system and the order is processed. Once an order is placed, the order invoice can be sent to the merchants. Percentages from the profits can be automatically divided up between the merchants, market site, and, if the merchants allow the associate program, the VSA host may also be included into the profit distribution. In some cases, a fulfillment warehouse is also included in the cut of the profits.

A cash on delivery payment type allows the user to schedule a delivery time and date in order to pay for their order upon delivery. The user may provide their billing info, shipping info, contact info and a delivery date in order to complete their order. Once such information is provided, a delivery confirmation is sent to either the merchant or fulfillment warehouse. The order is delivered on the scheduled date, specified by the user. Upon delivery, the user may pay for their order with cash. Percentages from the profits can be automatically divided up between the merchants, market site, and, if the merchants allows the associate program, the VSA host may also be included into the profit distribution. In some cases, a fulfillment warehouse is also included in the cut of the profits.

A cell phone number payment type allows the user to input their cell phone number in order to link their phone number to their credit card information provided in their market site user account. For this payment type to take place, the user can create a user account with the market site. From their account page, the user can provide their billing info, shipping info, credit card info, contact info and mobile phone number. Once such information is submitted, a confirmation text can be sent to the mobile phone number provided. The user can then approve the activation by replying the text message and entering a pass code. Once approved, the user's payment information can be associated with their mobile phone number. The user may now choose the cell phone payment type to complete their order transaction on a VSA. During the checkout process, the user may be asked to provide their mobile phone number to proceed in the transaction. Once the mobile phone number is submitted, an order confirmation text message can be sent to the mobile phone number and awaits approval. Once approval is accepted, the user's credit card can be charged and order submitted to the merchants or fulfillment warehouse. Percentages from the profits can be automatically divided up between the merchants, market site, and, if the merchants allows the associate program, the VSA host may also be included into the profit distribution. In some cases, a fulfillment warehouse is also included in the cut of the profits.

An associate program allows users to host the merchant's VSA on their own URLS (e.g., MySpace, Facebook, Blogger, a personal URL, etc.) or send out as an email or SMS text message. In return the host can receive a percentage of profits made from every transaction from the VSA hosted on their URL or VSA that they may have sent out as an email or SMS text message. The merchant may determine the percentage allotted to the VSA associate host.

A viral distribution module allows users to make a copy of a VSA and embed it on their own URL page (e.g., MySpace, Facebook, Blogger, Personal URL, etc.) or send out as an email or SMS text message. There are many ways that a VSA may be distributed. For example, a VSA can be distributed from the source site, from an existing VSA, from a Social Networking Site (SNS), from an email, from a cell phone text message, and from potentially other distribution mechanisms.

A user may install the VSA from the original market site. To do this, the user can go to the market site web store and copy the embed code or choose to link their social networking site account to the VSA. After copying the embed code, the user can paste the code onto their URL page. Linking their social networking account may require the user to log into their social networking account to connect the VSA to their social networking page.

The user may also obtain the VSA embed code from an existing VSA hosted on an outside web page or on an email. To do this the user can go to the share tab within a VSA and go through the registration steps. After going through registration, the user may be given the embed code or pass code to install it to their social networking site.

The user may install a merchants store directly through their social networking site application (e.g., MySpace, Facebook, Ning, etc.). The VSA can be registered as an official application where the user may add it to their page. Once added, the user can go through a registration process to obtain a pass code that may activate the VSA and install the VSA application on their social networking site page. If the user fails to get proper registration, the VSA may not load.

The user may also have the option of sending the VSA to a designated email. To do this, the user can go to the share tab of a VSA and choose the email option. The user can go through the steps to send a VSA email. The recipient may receive the VSA in their email inbox. The recipient may then be able to make a full secure purchase from within the email itself and choose to forward the VSA to another email address.

The user may also have the option of sending the VSA to a designated cell phone number as a text message. To do this, the user can go to the share tab in a VSA and choose the text message option. The VSA Text Message recipient may receive the VSA in a text message. From there, the recipient may be able to make a full complete purchase without leaving their text message and choose to forward the VSA to another cell phone number.

There are also many other potential enhancements that can provide a better shopping experience for the user. There are also many potential enchantments that can allow merchants to have more control over VSAs associated with their products.

User enhancements may include a shared universal shopping cart, a payment method, product reviews, live customer support chat, a most wanted list, price comparison tools, in-store pickup and a collaborative payment option.

A shared universal shopping cart may be implemented for some embodiments. When a user logs into their market site member account through the VSA, market site, social networking site VSA application, or mobile application, the user can gain access to the shared universal shopping cart feature. This feature may allow the user to share the same shopping cart, which is displayed through the VSA, with other source sites associated with the network of VSAs. If the user adds a product to their shopping cart through the VSA and visits a source site, the product may be in the market site's shopping cart as well. Any changes made to the market site shopping cart can be updated on the VSA shopping cart, and vice versa. The same action is reflected in both the social networking site VSA application and mobile application.

According to some embodiments, the user has the ability to access reviews or create a review for a product. When the user selects reviews, the screen may display the reviews most relevant and give the user the option to query the results as they wish. The user may also be able to vote on whether they found the reviews helpful or not. In addition to the reviews feature, the user may rate individual products, brands or merchants. Customer comments/feedback may also be associated with reviews.

According to some embodiments, the merchant has the option to assign a designated customer support chat contact to take advantage of the live customer support chat feature. The user can click on the customer support option in the VSA to chat with either a market site representative or merchant representative.

A user may have the ability to create a list of most wanted products from the market site, social networking site VSA application, or mobile VSA application and turn it into a VSA. With this VSA, the user can distribute it via a social networking site, email, or text message. The user may typically be a registered member of the market site in order to take advantage of this feature. By becoming a registered member, the user's shipping address information is saved with their account. When the user's friends purchase a product from the user's VSA most wanted list, the product can be shipped to the owner of the VSA most wanted list.

A price comparison tool allows a customer to compare the price of a product from merchants on the Internet and merchants selling the product at retail store locations. When a product is being viewed in the VSA, the user may select the price comparison button to display a listing of different price points that the selected product may be sold at on the Internet an at retail store locations. The listing can be sorted by ratings, price, name and most popular. Clicking on a web listing can display the web sites product description, price and product options for the product. The user may also purchase the product from the web site without leaving the VSA. Clicking on a retail store location listing can display the product description, price and product options for the product as well. In addition to a store location listing, the user may view a map with directions to the retail store. The user may also put the product on hold for in-store pickup at the selected retail store location.

An in-store pickup option allows the user to place the items in their shopping cart on hold at a local retail store location. There are different possible ways to get to this feature in the VSA. The user may click on the hold product button to display a list of different retail store locations that the products in the shopping cart may be sold at. Once a retail store location is selected, the user may place the products on hold under their name and phone number. The retail store can be notified to hold the product under the specified name and number. Another way to use this feature is when navigating the price comparison list. The user may select a retail store listing on the price comparison list and have the option to hold the product at the selected retail store listing. Yet another possible way of using the in-store pickup option is by way of the checkout section of the VSA. When the user select a payment type, during checkout, they may select in-store pickup. Once selected, a list of local retail stores that carry the products in their shopping cart can be displayed. The user may then select retail stores to hold their product for pickup.

A collaborative payment option can be used in conjunction with a VSA most wanted list. It allows multiple users to take part in a contributive payment towards a product listed on a user's most wanted list. Once collected amount of contributions equal the cost of the product, the credit cards can be charged and order sent to the owner of the VSA most wanted list. Contributors can choose to remain anonymous or be known through an announcement. Cash on delivery payment type may not available for the contributors. But the owner of the VSA most wanted list may have the option to pay the remaining fees due for the order. If the VSA most wanted list owner chooses to pay the remainder, they may use all payment types including cash on delivery.

A merchant enhancements may include a controlled distribution list. Potential VSA hosts may go through a registration step when obtaining their VSA embedded code. VSA hosts could provide the exact URL where the VSA may be hosted. If a VSA host fails to provide a URL, some embodiments may not allow the VSA to load at the URL. The VSA URL locations can then be compiled into a distribution list. This list allows the merchant to monitor and manage the distribution of their VSA on specific URLs. A Merchant may then have the option to block specific URLs listed in the distribution list. URLs blocked by a merchant may not be able to load the VSA at the URL.

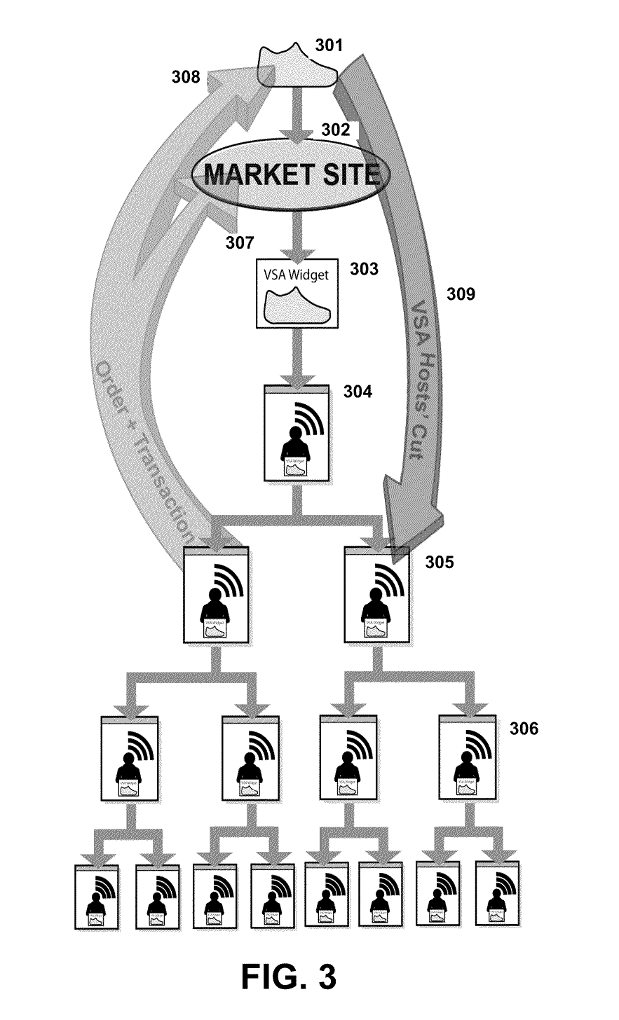

FIG. 3 illustrates one method of VSA distribution across the Internet through personal web pages, emails, social networking site application and mobile application. Personal web pages are web pages that are not owned or managed by a market site. Personal web pages may also include social networking site pages. In the illustrated example, a market site can be the VSAs original source. VSAs existing on social networking site applications and mobile applications are linked to a market site. FIG. 3 illustrates the flow of distribution and the links between the VSA host, merchant (or in some cases, a fulfillment warehouse) and market site.

At 301, a merchant has various products that the merchant wishes to sell. For example, these products may be part of an electronic or other product catalog. This information can include inventory information, product descriptions, prices, etc.

At 302, the merchant creates an account on a market site and connects the merchant's product inventory information into the market site. The market site gives the merchant a web store utilizing the merchant's product information, inventory information, etc.

At 303, the web store is transformed into a contained application, called the Viral Store Application (VSA). A VSA allows users to browse the product inventory, add products to their shopping cart, and facilitate a secure transaction between both parties. All this can be done from a separate location apart from the market site via the VSA. For example, at 304, users can take the VSA and distribute it personally by hosting it on their social networking sites, sending it as an email, or sending it as a text message. In some cases, as shown at 305, visitors of the hosted VSA can make a copy of the same VSA and distribute it using the same methods previously stated. That is, the viral store application can be copied, in whole or in part from one remote location, e.g., one individual's personal web site, blog, social networking site, distributed email, or text message to another individual's location (i.e. personal web site, social networking site, distributed email, or text message). As shown at 306, steps 304 and 305 have the potential to be repeated an infinite number of times, hence being “viral” in that the VSA can be copied and shared between pages and users remote from the original marker site.

At 307, the VSAs can be directly linked back to the merchant and market site. As a purchase is made from a VSA, the transaction can be sent to the market site. Here it can be held until the order purchase is complete and secured. Alternatively, as shown at 308, the order from a VSA location can be sent directly to the merchant and market site. If the merchant is not responsible for fulfillment, the order may be sent to the market site and fulfillment warehouse instead. Once the merchant has received the order, they are responsible for fulfillment unless the market site has the products in their fulfillment facility.

At 309, if the VSA Host registered for the associates program, they may receive a cut from the profits made from the transactions gathered from their VSA location. The market site can hold their cut until some time, e.g., 15 days, has passed from the estimated delivery date without complaint from the customer.

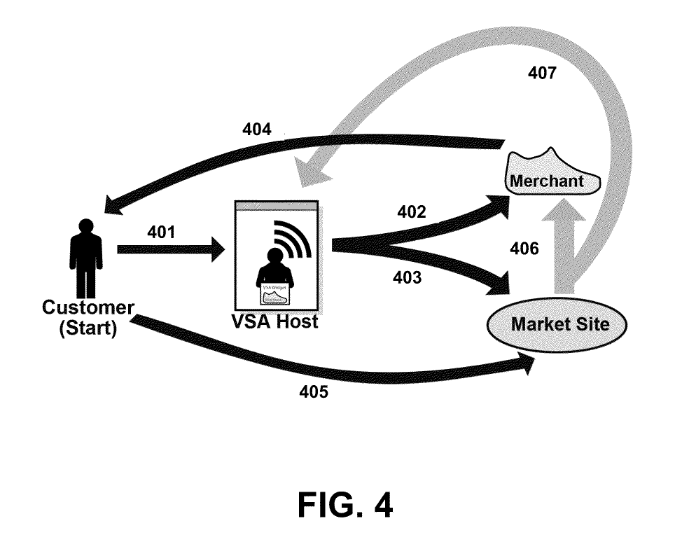

FIG. 4 illustrates an exemplary VSA order and transaction flow when a customer makes a purchase from a VSA location. No matter where the VSA is hosted, the order and transaction flow may remain the same. This example includes the flow of a VSA Host that is registered with the associates program.

At 401, a customer can visit a VSA host location and makes a purchase from the VSA. The order information can be sent 402 to the merchant, where it awaits fulfillment. If the merchant is not responsible for order fulfillment, the order can be sent to a fulfillment warehouse in place of the merchant. At 403, the secured payment transaction is sent to the market site. From here it may be held until the order is fulfilled successfully. This step may occur concurrently with step 402. At 404, the merchant or fulfillment warehouse fulfills the order and ships it to the customer. The order can be shipped with an estimated delivery date. The customer and market site may be notified of this estimated delivery date.

In some cases, as shown at 405, the customer may be given some period of time, e.g., 15 days from the estimated delivery date or actual delivery date, to file a complaint about their order. If the time period passes with no filed complaints, the market site may be notified that the order was delivered successfully. At 406, once the market site receives notification that the order was received successfully, the profits from the transaction may be distributed to the merchant and in some cases, the fulfillment warehouse. If the VSA host registered with the associates program, the VSA host may, as shown at 407, receive a cut of the profits made from the transaction that took place on their VSA location.

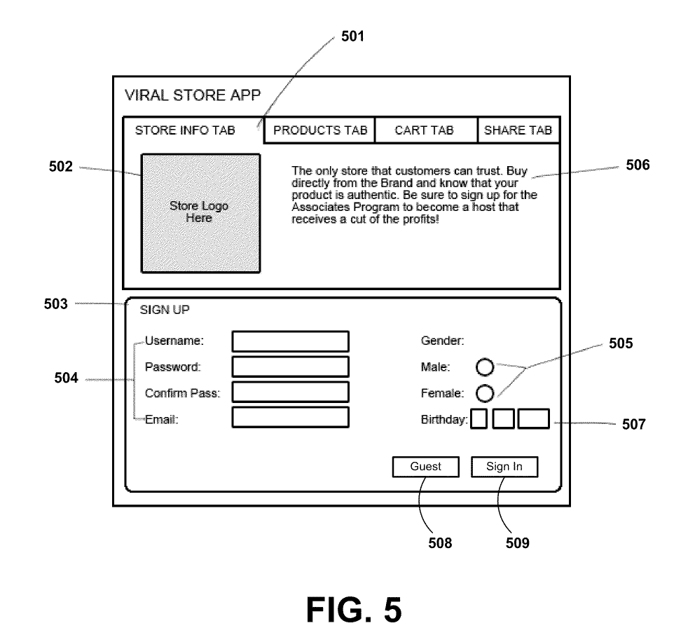

FIG. 5 is a screenshot illustrating an exemplary user interface of a VSA Store, formatted for a web page and email distribution, according to various embodiments. More specifically, this example illustrates the layout of a store information tab 501 located in the VSA. The VSA can be in direct communication with the merchant's web store information located on the market site. This information can be dynamically updated when changes are made from the market site. This tab 501 can dynamically display store information, such as the store's description.

More specifically, the Store Info Tab 501 can be located on the VSA user interface. Clicking on this tab may open up the store information page of the VSA. In response, the Merchants Store Image 502 can be displayed as illustrated in FIG. 5. The store image can be a direct representation of the store image created on the market site. Any modifications made to the store image, from the market site, may dynamically update the store image on the VSA. For example, the Store Description 506 can be directly connected to the store description created by the merchant on the market site. If the store description is modified on the market site, the VSA store description can be dynamically updated.

The Sign Up Panel 503 as illustrated here can allow the user can sign up to create an account with the market site that this VSA is created from. Users may typically have an active account with the market site in order to take advantage of VSA enhancements such as: universal shopping cart, shopping history, associates program, most wanted list and others. Through textboxes or other elements as illustrated at 504, the user may be required to provide a username, password, and email address to create an account with the market site. Additionally, through radio buttons as illustrated at 505, the user can to state their gender. Via textboxes or other elements at 507, the user can provide their birth date. In some cases, members may be required to be a certain age or older in order to create an account with the market site. For example, if the user submits a birth date that is younger than 13 years of age, they may not be able to create an account. If the user has already has a registered market site account and wishes to log into their user account, they may do so by clicking on the Sign In button 509. Guest login/checkout is available by clicking on the Guest button as illustrated at 508. If a user logs in using guest checkout, they may complete an order transaction but may not be able to take advantage of certain user enhancements like, associates program or most wanted lists.

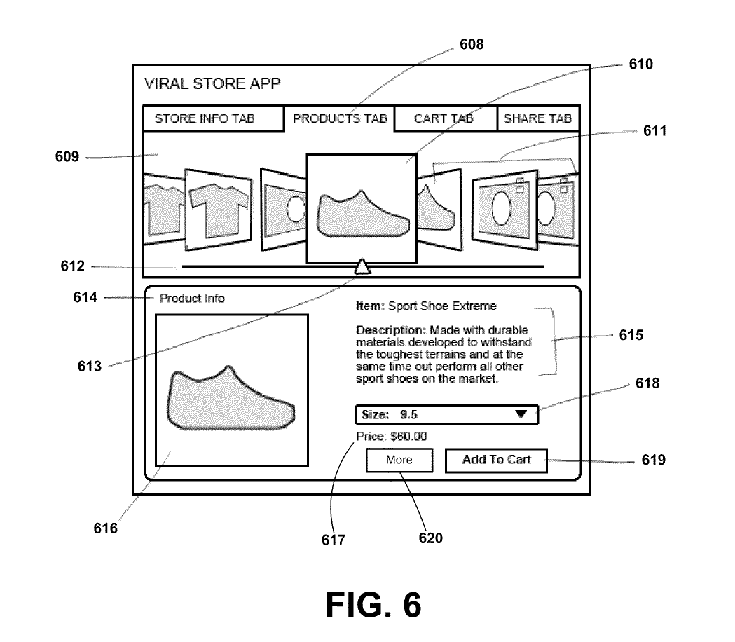

FIG. 6 is a screenshot illustrating an exemplary user interface of a VSA Store, formatted for a web page and email distribution, according to various embodiments. This example illustrates the contained VSA web store dynamically connected to the market site web store including dynamic product information presented in a product information tab 608. Clicking on this tab 608 may display the merchant's products that are for sale on their market site web store. The VSA version of the web store is a compressed variation of the market site web store that allows customers to browse through the merchant's market site web store from a location outside the market site. Furthermore, the VSA shopper can add products to a shopping cart, where it awaits checkout.

The VSA products tab 608 dynamically communicates with the merchant's market site web store information and the merchant's product inventory. If a modification is made from the market site web store, the VSA product tab may dynamically update. In addition, the VSA product inventory directly communicates with the merchant's product inventory. When inventory is out of stock in the merchant's product inventory, the product may display as “Out Of Stock” on the VSA Products Tab 608.

Clicking on the Products Tab 608 may open up the VSA products page. The products page displays a direct representation of the merchant's web store located on the market site. It connects the market site web store with the VSA web store representation.

The Product Sorter 609 allows the user to sort through the various products sold from the merchant's VSA web store. It incorporates a product thumbnail view that allows the shuffling of products from left to right. The Selected Product Thumbnail 610 may be centered. Clicking on a product thumbnail may center it onto screen. The selected product thumbnail may have its product information loaded up in the product info panel 614. Product Thumbnails 611 that are unselected may be displayed to the sides of the currently selected product thumbnail. Clicking on one of these product thumbnails may center it on screen and the product thumbnail may be currently selected 610. The Product Thumbnail Scroll Bar 612 aids the user in sorting through the product thumbnails. It is made up of two parts, the Scroll Bar 612 and Scroll Icon 613. Clicking and dragging the Scroll Icon 613 may dynamically move the product thumbnails horizontally. The scroll icon acts as a marker to sort through the various product thumbnails. Dragging the scroll icon to the left may begin to scroll through the product thumbnails towards the left. The product thumbnail that is in the center may dynamically load its product information in the product information panel.

The Product Information Panel 614 displays detailed information of the currently selected product thumbnail. This panel is made up of a Product Image, Product Name. Product Description, Product Options, Product Base Price, and an Add To Cart Button. All product information displayed on this VSA is directly connected to the product information on the Merchant's market site web store and merchant's product inventory. The Product Name and Product Description 615 are displayed in this area. Both forms of information are directly connected to the product name and product description from the market site web store. When a change is made on the market site, the change may be updated on the VSA web store. The Product Image 616 is an image that the merchant uploaded on the market site web store to represent the product. Clicking on the product image may open up an enlarged product image view of the product image. This image view may allow the user to zoom into the image, see different views of the product, review ratings, and activate live chat customer support. The Base Price 617 of the product is displayed where shown in FIG. 6. The base price may reflect the cost of the product before tax, shipping, and additional product options are added on. Product Options 618 may be displayed if the product inventory provides it. Product options allow the User to select specific options for the selected product currently loaded in the product info panel. For example, if the product is a shoe, the user may have the product options of size to choose from. An Add To Cart Button 619 or other element may be provided in the product info panel. Clicking this button may add the product, with the currently selected product options, to the user's shopping cart. From there it may await checkout.

The More drop down button 620 displays navigational buttons to additional features and tools the user may use with the current product selected. Selecting specific buttons allows the user to take certain actions for the product such as: Add to most wanted list, view reviews, price comparison, hold product, and share product button.

Selecting add to most wanted list from the more button 620, allows the user to add the currently selected product to their most wanted list. From the most wanted list interface, the user may be able to manage and edit their list into a VSA.

Selecting view reviews from the more button 620, allows the user to view customer reviews for the currently selected product. When selected, the user may be taken to the reviews page for the product. From the reviews page, the user may read through a list of reviews, comments and ratings. They may also rate and comment with their own review for the product.

Selecting price comparison from the more button 620, allows the user to view a listing of the currently selected product sold at different locations on the Internet and retail store locations. The list may be sorted according to price, location name, web only, and retail only. This tool helps the user find the best possible price point to purchase the product. The product listings may or may not be directly sold from an affiliated market site and the VSA. Selecting a web listing, allows the user to purchase the product from the web site hosting the product, while maintaining a session with the VSA. Selecting a retail store location listing, allows the user to put the product on hold at the store and view directions to the retail store.

Selecting hold product from the more button 620, allows the user to view a retail store listing that sells the currently selected product. Once a retail store is selected, the user may request to put the product on hold at the selected store. In addition, the user may view a map and directions to the retail store within the VSA.

Selecting share product from the more button 620, displays the share interface for the currently selected product. From the share interface, the user may have the option to share create a VSA with only the single product in it. The created VSA may then be distributed onto a personal web page, blog, social networking site application, mobile application, email or text message.

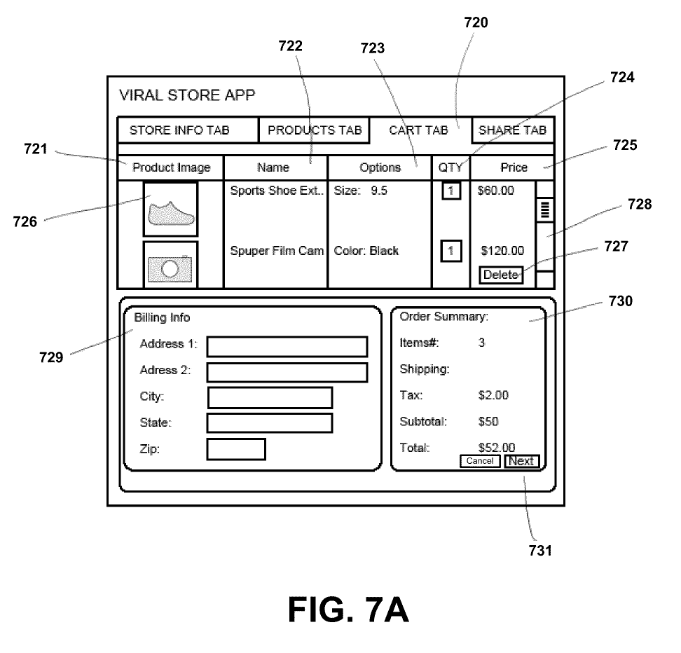

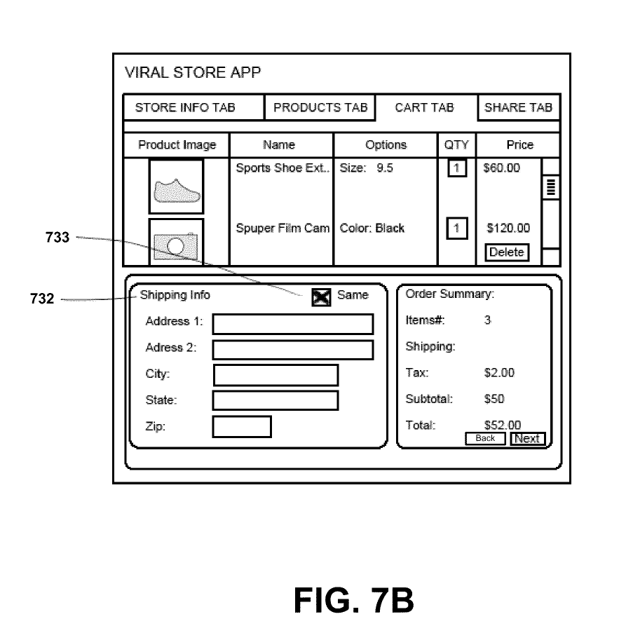

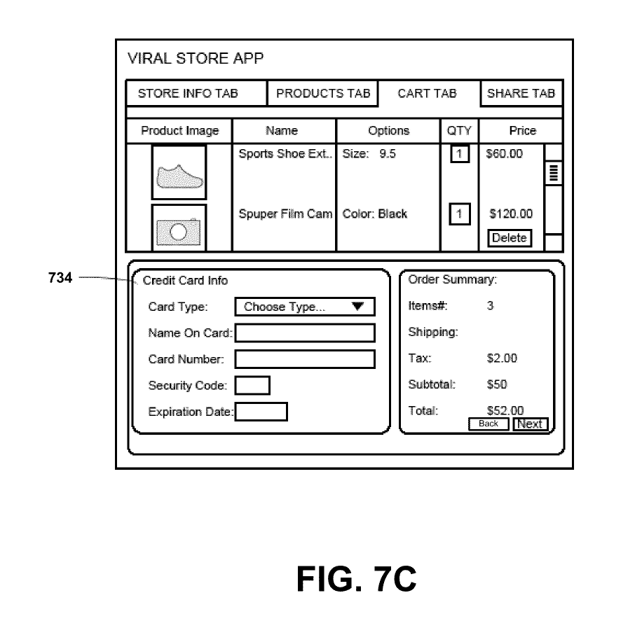

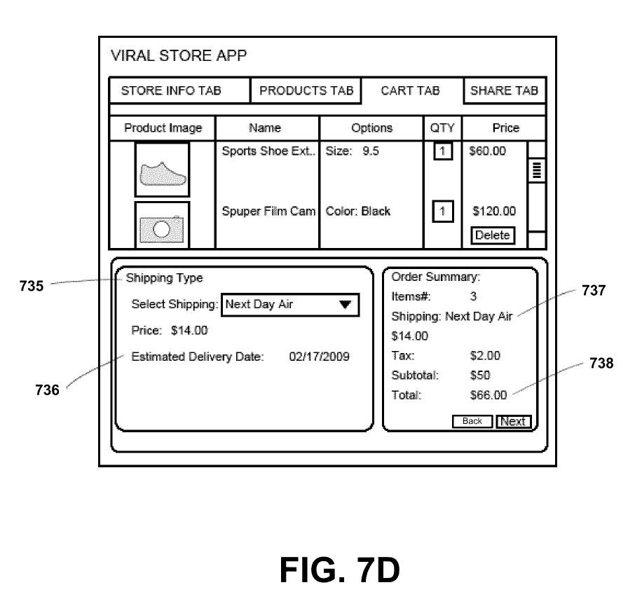

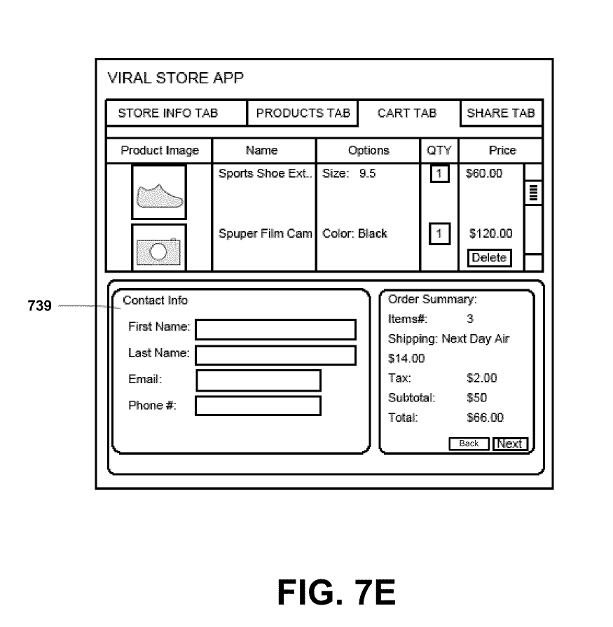

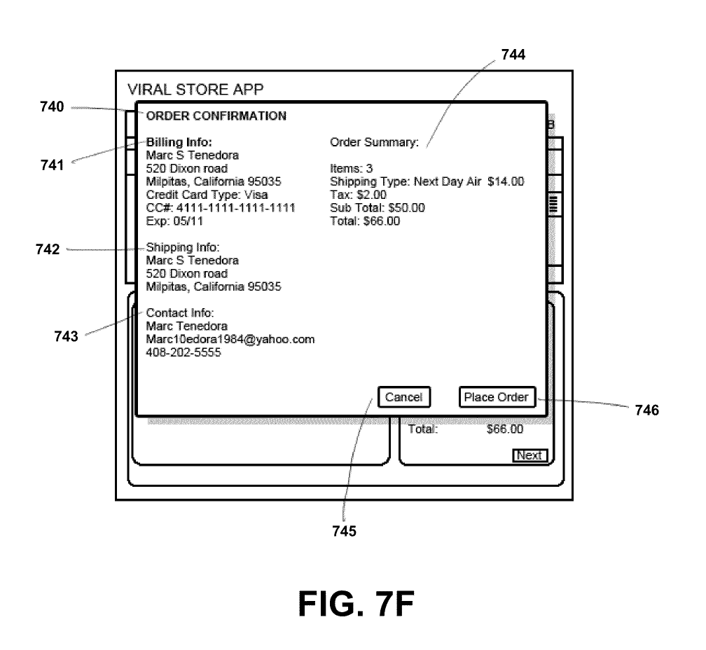

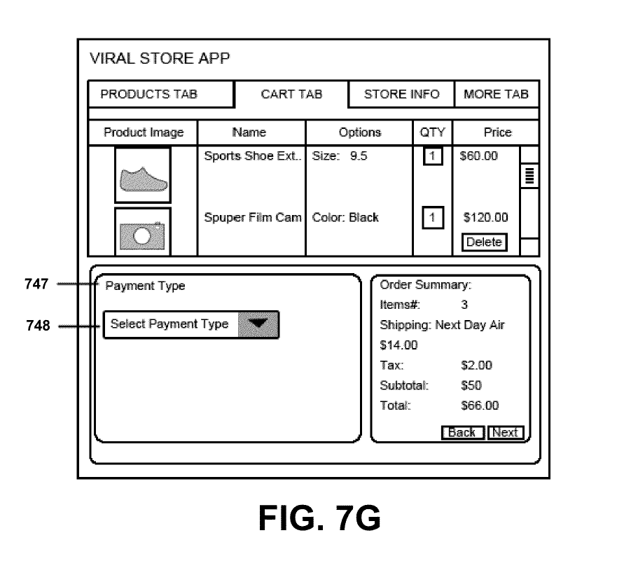

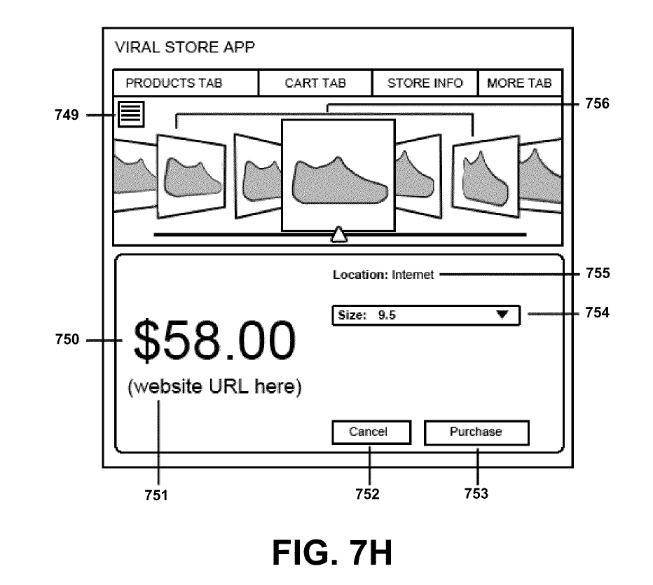

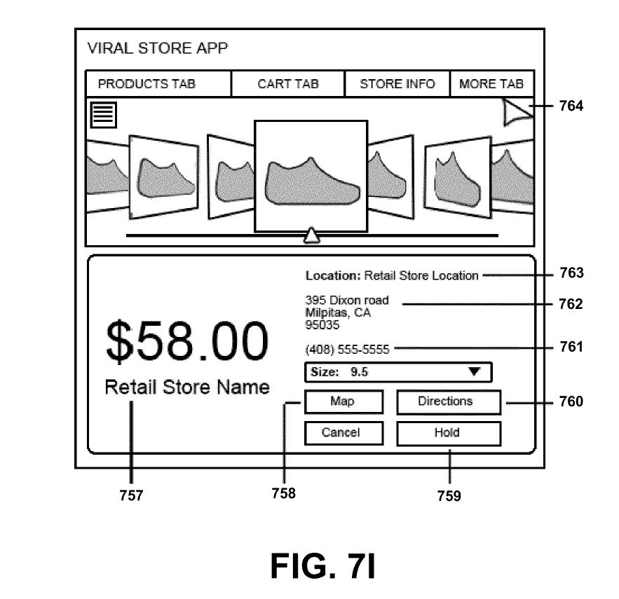

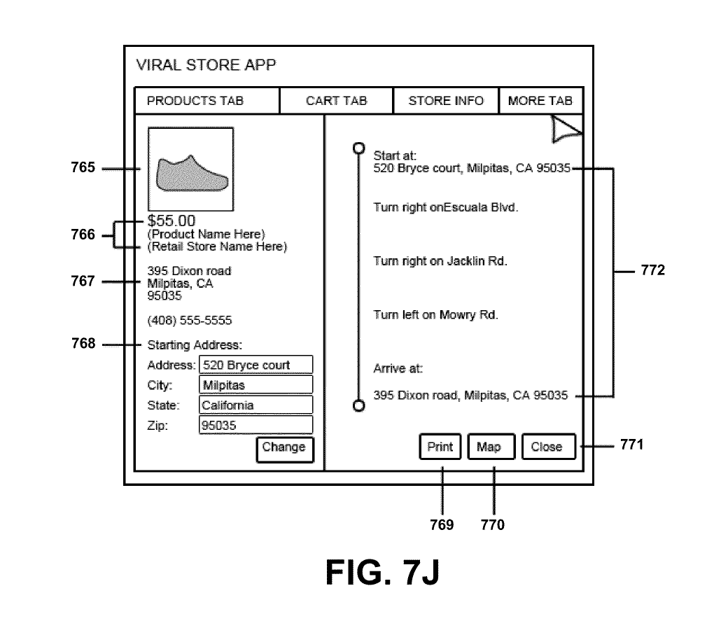

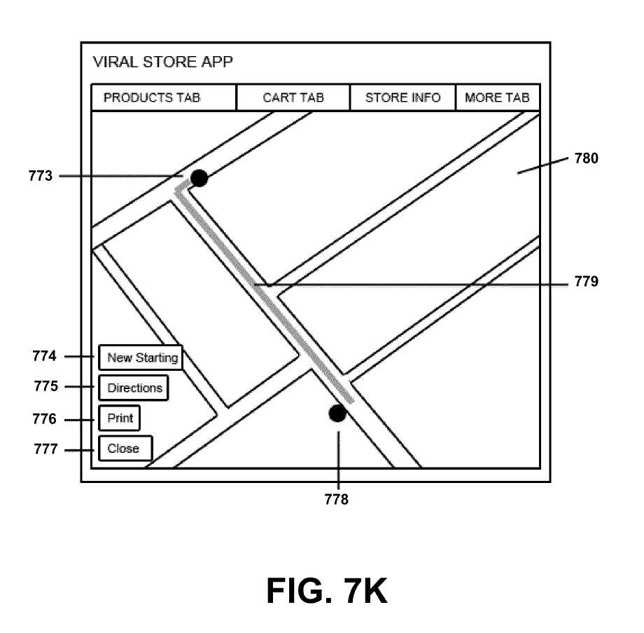

FIG. 7A illustrates and exemplary VSA shopping cart feature, formatted for a web page and email distribution. Clicking the Cart Tab 720 may open up the user's VSA shopping cart. All products added from the products tab 608 are displayed here. Furthermore, the VSA shopping cart may be universal. That is, products that are added to the user's shopping cart from the VSA may remain in the shopping cart when the user visits other VSAs or other market sites connected to the network. The same may work vice versa. The user may be able to make a complete secure transaction from the Cart Tab 720.

Clicking on the Cart Tab 720 may open up the user's VSA shopping cart and checkout. The shopping cart may be made up of a series of columns that display the products added to the user's VSA shopping cart. The checkout may consist of a series of steps that take place in the Cart Tab 720. The Product Image Column 721 is the first column category within the VSA shopping cart illustrated here. This column 721 can display product thumbnails of the product inside the VSA shopping cart. The Name Column 722 can be the second column category within the VSA shopping cart. This column 722 can display the name of the product added to the VSA shopping cart. The Options Column 723 can be the third column category within the VSA shopping cart. This column 723 can display selected product options for the product added to the VSA shopping cart. The Quantity Column 724 can be the fourth column category within the VSA shopping cart. This column 724 can display the amount of product, with the selected product options, inside the VSA shopping cart. The Price Column 725 can be the fifth column category within the VSA shopping cart. This column 725 can display the base price along with any additional product options prices. The Product Thumbnail 726 can be displayed inside the product image column 721. As shown here it is a thumbnail representation of the product image of the product added to the VSA shopping cart. Clicking on the Product Thumbnail 726 may open up an enlarged product image view of the product image 616. Clicking the Delete Button 727 may delete the selected product from the VSA shopping cart. To select a product in the VSA shopping cart, the user may click on one of the rows of products. Once clicked it may be marked as selected by displaying as highlighted. The user may then, be able to delete the product from their VSA shopping cart. The side Scroll Bar 728 may aid the user in shuffling vertically through their VSA shopping cart products.

The Checkout Panel 729 may be displayed as illustrated in FIG. 7A. Checking out may happen in a series of steps. The billing info can be the first step towards a complete checkout. In this step, the user may be required to enter their billing information, associated with their credit card, by providing the following information: address, city, state, and zip code. If the user is signed into their market site account and has saved their billing info in their user account settings, then the billing information may be pre-filled. The Order Summary Panel 730 may display dynamically updated calculations based on the user's VSA shopping cart and shipping options. As products are added/deleted from the VSA shopping cart, the order summary panel may calculate: number of products, shipping type, shipping cost, tax, subtotal, and total. When the user is finished with step one of the Checkout Process 729, they may proceed by clicking on the Next Button 731.

FIG. 7B illustrates another step in the exemplary checkout process. Through this interface, the user may fill out their Shipping Information 732 in the shipping info panel. They may be requested to provide an address, city, state, and zip code where their order may be shipped. If the user wishes to use the same shipping address as the billing address, the user may click on the “Same” Button 733. Clicking this button may automatically fill out the requested shipping info with the same address provided for the billing info. If the user is signed into their market site account and has saved their shipping info in their user account settings, then the shipping info may be pre-filled out.

FIG. 7G illustrates another step in the exemplary checkout process. Through this interface, the user may choose a payment type 747 to proceed with their checkout. The user may select from a drop down button 748 that lists multiple payment types. Payment types include: Phone bill, credit/debit card, bank transfer, mobile phone number, cash on delivery and in-store pickup.

FIG. 7C illustrates another step in the exemplary checkout process, if the user chose to checkout using the credit/debit card payment type. Through this interface, the user can be asked to provide valid credit card information 734 to make an order purchase. The user can be requested to provide the card type, name on card, card number, security code, and expiration date.

FIG. 7D illustrates another step in the exemplary checkout process for payment types other than in-store pickup. Through this interface, the user can be asked to select a Shipping Type 735. The user selects a shipping type by selecting from a drop down button of available shipping types. The merchant sets the shipping types from the market site. In addition to displaying the cost for the selected Shipping Type 735, the Estimated Delivery Date 736 of the shipment can be displayed. The estimated delivery date can be used by the market site to determine when the grace period starts for the customer to file a complaint. For example, if 15 days pass from the estimated delivery date and the customer has filed no complaints, the transaction can be considered complete. Profits from the sale can then be released to the merchant and associate host. As the user selects different shipping types, the shipping calculation of the Order Summary Panel 737 can be dynamically updated in real time. In addition to the shipping calculation of the order summary panel dynamically updating, the Total 738 of the order may also dynamically update.

FIG. 7E illustrates another step in the exemplary checkout process. Through this interface, the user may provide Contact Information 739 in case there is an issue with their order. They are asked to provide a first name, last name, email address, and phone number.

FIG. 7F illustrates another step towards completing the exemplary VSA checkout for a credit card payment type. The contents of this illustration may be modified in order to cater to the payment type the user has chosen. In this interface, the Order Confirmation Pop Up Window 740 can be displayed as the last step of the checkout process. From here, the user may review the checkout information they provided. If any of the information is incorrect, the user may be able to click on the section and edit it on the spot. For example, Billing Info 741, that the user provided, is displayed as illustrated in FIG. 7F. Clicking on the billing info text allows the user to edit his or her billing information directly from the window. Shipping Info 742, that the user provided, can be displayed as illustrated in FIG. 7F. Clicking on the shipping info text allows the user to edit his or her shipping information directly from the window. Additionally or alternatively, Contact Info 743, that the user provided, can be displayed as illustrated in FIG. 7F. Clicking on the contact info text allows the user to edit their contact information directly from the window. The Order Summary 744 can be displayed as illustrated in FIG. 7F. If the user needs to edit their order, they can click on the order summary text to be taken back to their Cart Tab 720. From the Cart Tab 720, they may be able to edit their shopping cart. When they proceed to the checkout process, all previously filled out information may remain filled out as they proceed through the steps. The user may choose to cancel their order by clicking on the Cancel Button 745. Clicking the cancel button clears all prior information and empties the VSA shopping cart. To finalize the user's order, the user may click on the Place Order Button 746. Clicking this button closes the order confirmation window. The order may begin the transaction process as in FIG. 4 (illustrating order and transaction flow).

FIG. 7H illustrates a price comparison feature for a product with a web listing. The user may use the price comparison tool to find the best available price for the product currently selected in their VSA. Once price comparison is activated, the product is listed 756 from highest to lowest available prices on the Internet and retail store locations. The user may sort through the thumbnail views of the product listing 756. By default, the listing may be displayed in thumbnail scrolling view. The user may change the view layout to list view by clicking on the view button 749. The listings may be sorted in multiple configurations including price, name, listing type, and more. When a web listing is selected, the location displays as Internet 755. The price point that the web listing sells the product may be displayed 750. The URL of the web listing 751 may also be listed when a web listing is selected. Clicking the cancel button 752 may close the price comparison feature and take the User back to their previous page. Clicking the purchase button 753 may or may not allow the user to purchase the product directly from the VSA. If the web page listing does not allow the VSA to integrate shopping carts with their current checkout system, then when the user clicks on the purchase button 753, the user can be linked to the URL where the product may be sold from. If the web page allows the VSA to integrate shopping carts with their current checkout system, then when the user clicks on the purchase button 753, the user may complete an order transaction for the product without closing the session with the VSA. Product options 754 are available for the user to select the types of product options they wish to purchase the product with.

FIG. 7I illustrates a price comparison feature for a product with a retail store location listing. The user may use the price comparison tool to find the best available price for the product currently selected in their VSA. Once price comparison is activated, the product is listed 725 from highest to lowest available prices on the Internet and retail store locations. When a retail store location listing is selected, the location 763 may read as retail store location. The address 762 of the selected store location may be displayed. In addition, the phone number 761 may also be displayed. The name of the retail store location 757 may be displayed underneath the price. Clicking on the map button 758 may load a map displaying the location of the users specified starting point to the retail store location. Clicking on the directions button 760 may load navigation directions to from the users specified starting point to the retail store location. Clicking the hold button 759 may place the product on hold, with the user's specified product options, at the currently selected retail store location listing. When a retail store location listing is selected, a page peel icon 764 may be displayed. Clicking on the page peel may reveal the map like with the actions outlined with the map button 758.

FIG. 7J illustrates navigational directions to a retail store location listing. When a retail store location is selected like in FIG. 7I, the user may click on the directions button 760, to display navigational directions FIG. 7J from the users specified starting point to the retail store location listing. On the navigational directions interface, the product thumbnail image 765 may be displayed on the left panel. Under product thumbnail image, may display product price (according to the selected retail store location listing), product name, and name of the selected retail store location listing 766. The address of the retail store location and phone number 767 may display on the left panel also. The starting address 768 allows the user to change the starting point of their navigational directions. A series of text fields allow the user to modify the starting point address at any time. The navigational directions from the user's specified starting point to the retail store location's address may be outlined in step by step instructions 772. Clicking the print button 769 may print the outlined instructions 772. Clicking on the map button 770 may display a map according to the locations outlined in the navigational directions. Clicking the close button 771 may close the navigational directions page and return the user back to their previous page.

FIG. 7K illustrates a map display of the location of a selected retail store location listing. When the user specifies a starting point address and clicks on the map feature, a map display 780 is viewed showing the location from the specified starting point to the currently selected retail store location. Two icon may be positioned on the map according to the two addresses provided. The first icon may be the starting point 773 that the user specified. The second icon 778 may be the currently selected retail store location. A trail 779 may be outlined according to the directions given from the starting point to the retail store location. Clicking the new starting button 774 may allow the user to input a new starting point address to map out. Clicking on the directions button 775 may display navigational directions from the specified starting point to the retail store location. Clicking the print button 776 may print the map. Clicking the close button 777 may close the map and take the user back to their previous page.

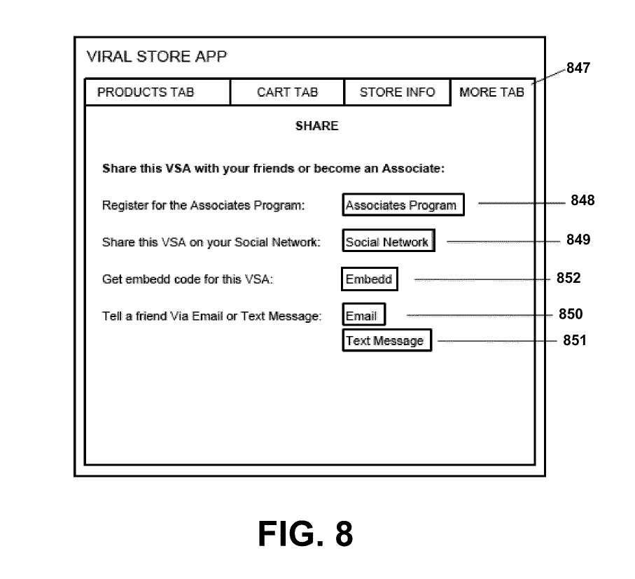

FIG. 8 allows the user to take a copy of this VSA and distribute it in various platforms as described above with reference to FIG. 3 (illustrating VSA distribution). As illustrated in FIG. 8, clicking on the Share Option, under the More Tab 847 opens the VSA distribution page. This page provides the user with different methods of distributing this VSA. Choosing a method of distribution guides the user through a series of steps before they are allowed to distribute this VSA. For example, clicking on the associates program button 848 takes the user through the steps to sign the user up as a VSA associate host. The associates program allows the VSA host to receive a cut of the profits made from their VSA location. Clicking on the Social Network Button 849 takes the user through the steps to obtain a copy of the current VSA to install on their social networking site pages. Clicking on the embed button 852 may display an embed code the user may use to copy and paste the VSA onto their own personal web pages (i.e. blogs, personal web pages, etc.). Clicking on the Email Button 850 may email the current VSA to specified email addresses provided by the user. The recipients may open the VSA through their email and are able to make a complete secure purchase without leaving their email. Clicking on the Text Message Button 851 sends the VSA via text message to specified cell phone numbers provided by the user. The recipients may open the VSA through their cell phone text message. From there they are able to link to the VSA using their mobile web browser, or if the recipient has the market site application installed on their phone, they are linked to the product page of the VSA in the market site application.

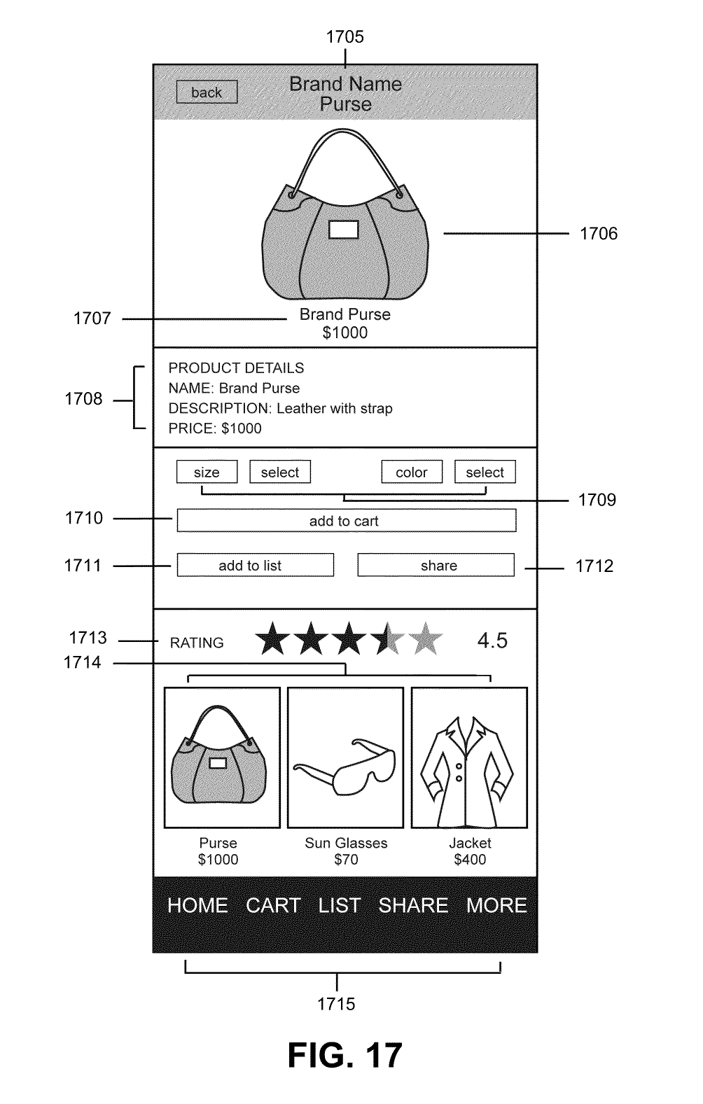

FIG. 17 illustrates an exemplary interface for a VSA product page laid out for a mobile phone format. Product features and tools mentioned in the above VSA descriptions remain the same for the mobile design except for specific layout configurations and in some cases, user interactions. The merchant's brand name and product name may be displayed on the product page 1705. Product images may be displayed on this page also 1706. Under the product image, may display the product name and base price 1707. A product info panel 1708 may be laid out displaying product name, description, and base price. Product options 1709 may be available for the user to select product specifications before adding the product to their shopping cart. Clicking the add to cart button 1710 may add the product to the mobile shopping cart with the specified product options 1709 selected by the user. Clicking the share button 1712 allows the user to share this product page as a VSA in a similar procedure outlined in FIG. 8. Product ratings may be displayed in a ratings panel 1713. Ratings display based on a 5 point system averaging ratings from customer service, quality, shipping, and price. Related products, based on meta data and similar customer actions, may be displayed in thumbnail form 1714. The related products can be displayed with a thumbnail, product name and base price. Clicking on a thumbnail may load the product page for the selected product. A series of navigational buttons 1715 can allow the user to navigate to different features and tools within the mobile phone application.

It should be understood that the user interfaces illustrated in the attached figures and described here are provided for illustrative purposes only and should not be considered limiting the various embodiments of the present invention. Rather, it is contemplated that such interfaces may vary significantly in format, content, layout, etc. depending upon the exact implementation of particular embodiments. These variations are considered to be within the scope of the present invention. For example, in some cases, the VSA may be presented in a user's web page as part of or accessible through a page peel advertisement. Embodiments of page peel advertisements and their associated systems and methods will be described in detail below. At a high level, various embodiments enable a number of beneficial features for web hosts, merchants, market sites, and consumers. A page peel ad can act as an embedded web store hosted on a web site. A page peel ad can allow a visitor of the web site to not only view the products advertised in the page peel ad, but also purchase the advertised items without having to leave the underlying web site. In other words, the user is able to interact with the advertisement while maintaining a session with the host site. A page peel ad can also be linked to inventory data from either a market site, a merchant, or other source.

Various features may make up a page peel ad. Some of those features may include: Page Peel Design and Animation, Advertisement, Modified VSA Web Store, Payment Gateway, and associate program.

A page peel ad may be presented and designed as an animated peeling advertisement. When the user clicks on the page peel icon, the page peel animation can be activated. The page peel icon may peel back to reveal the advertisement. On the fold of the peel is the web store and checkout for the product being advertised.

A page peel ad may provide a method to creatively advertise a product and enable the user to purchase the product directly from the advertisement. When a merchant creates a page peel ad campaign on a market site, they can create an advertisement to represent their product on the page peel ad. The advertisement can be in different forms, such as: static image, animated, or interactive. A static image displays as a still image that cannot be interacted with. An animated version is an animated image that has moving graphics. An interactive version allows for user interactivity such as clickable objects or a web game.

A VSA web store is a representation of the web store page that the merchant creates on the market site. One difference between a web store page that appears on a market site and a VSA web store that appears in a page peel ad is that instead of displaying the whole market site web store, a page peel ad may only display the VSA web store portion that represents the product or products currently being advertised. Because the page peel ad VSA web store can be directly connected to the web store page on the market site, when information is updated on the market site, the information will automatically update on the page peel ad. A user is able to view the product information and choose product options like size, color, etc. before adding the product to their shopping cart.

A page peel ad can facilitate a live and secure transaction directly from the ad. By facilitating tools and features to make a live transaction from the ad, the user does not have to leave the current site that they are on. The payment gateway for the page peel ad may include a checkout and a shopping cart option.

The page peel ad associate program allows the web host and advertisers to break from the traditional pay-per-click ad payment system. Instead of paying a web host for every ad click that comes from their site, the page peel ad associate program allows the web host to gain a cut from every product sold or added to a shopping cart from their site. Every time the web host makes a sale from their hosted page peel ad, they can receive a set amount of profits gained from that sale. In addition, if the customer added the product to their shopping cart, from a page peel ad hosted on the site, the host can receive a set amount of profits gained when the customer checks out their shopping cart.

There are also other enhancements that can provide a better shopping and advertising experience for the customer and advertiser. For example, customer enhancements may include the same user enhancements outlined in the VSA application. (i.e. Universal shopping cart, multiple payment options, sharing tools, etc.)

A shared universal shopping cart may be implemented for some embodiments. When a user logs into their market site member account through the page peel ad, the user can gain access to the shared universal shopping cart feature. This feature may allow the user to share the same shopping cart, which is displayed through the page peel ad, with other market sites associated with the network of market sites. If the user adds a product to their shopping cart through the page peel ad located on a hosting web page and visits a market site, the product may be in the market site's shopping cart as well. Any changes made to the market site shopping cart can be updated on the page peel ad, located on the previous web page, shopping cart and vice versa.

An advertiser may be given various tools and features to help create, manage and distribute their page peel ad campaign. Some example tools may include a controlled distribution list, a targeted ad system, and a share component.

A merchant enhancements may include a controlled distribution list. Potential page peel ad hosts may go through a registration step when obtaining their page peel ad embedded code. Page peel ad hosts could provide the exact URL where the page peel ad may be hosted. If a page peel ad host fails to provide a URL, some embodiments may not allow the page peel ad to load at the URL. The page peel ad URL locations can then be compiled into a distribution list. This list allows the merchant to monitor and manage the distribution of their page peel ad on specific URLs. A Merchant may then have the option to block specific URLs listed in the distribution list. URLs blocked by a merchant may not be able to load the page peel ad at the URL.

A targeted ad system may calculate potential matches between the page peel ad campaigns and the web site host URLs. When the merchant creates a page peel ad campaign, they may be required to take a survey that determines their campaign's target audience and demographic. For example, it may not be desirable to advertise auto parts on a cooking website. Page peel ad web hosts may also take a survey to determine their target audience and demographic.

A share component can allow a small or a big website owner to use the page peel ad application on their own web pages. Web hosts may be required to create an account and take a survey that determines their demographic. Once the information is collected, web hosts can be given the embed code that allows them to install the application onto their web page. The targeted ad system calculates the best possible ads to display on their page peel ad application.

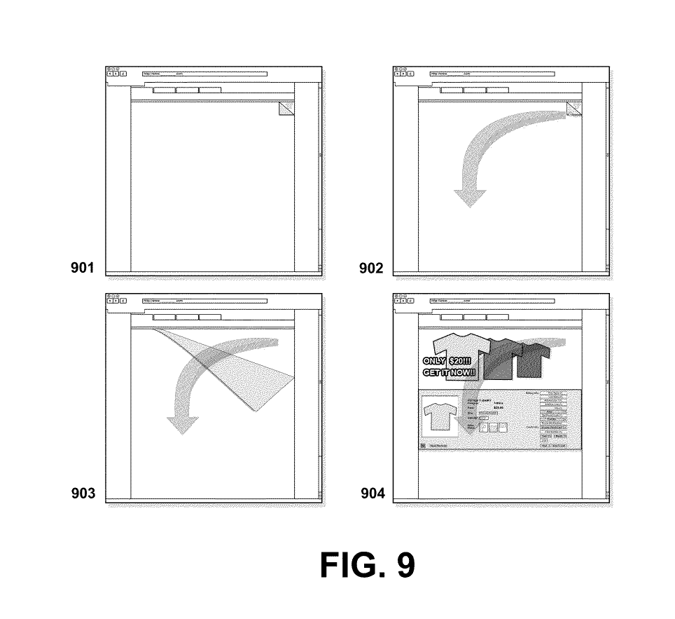

FIG. 9 shows how the user interacts with the page peel ad and displays an example of how it animates when activated according to various embodiments. At 901, the initial layout of the page peel is in the form of a small page peel icon. The placement of the page peel icon can be positioned in multiple places on the web page. In this example the page peel icon is located on the top right corner of the web page. At 902, the user clicks on the page peel icon to activate the page peel animation. At 903, the page peel folds downwards and peels away the front page of the web page. At 904, once folded down, the page peel ad is revealed above the fold. Below the fold can contain the VSA web store and checkout. When the page peel ad closes it folds back the way it unfolded.

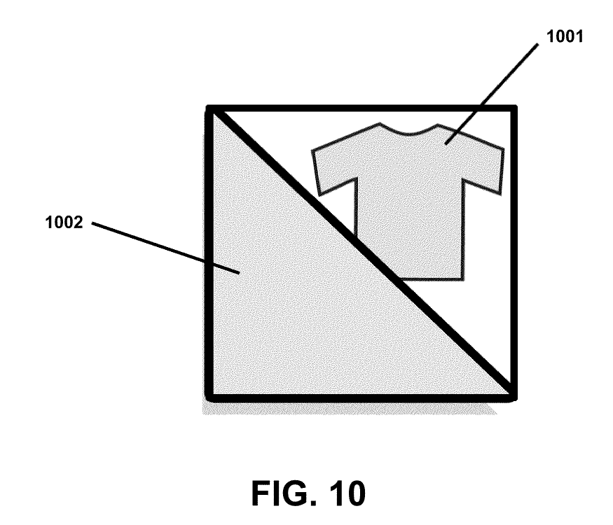

FIG. 10 shows the design and layout of the page peel icon according to various embodiments. The page peel icon is the initial layout of the page peel ad. Clicking on the page peel icon can activate the page peel animation, which ultimately reveals the actual page peel ad. Here, area 1001 illustrates where the actual page peel ad is displayed. In icon form, the page peel ad can be displayed as a smaller version than the actual page peel ad. In area 1002, the top layer of the page peel can be shown. As shown here, it can be designed to look like a folded over piece of paper.

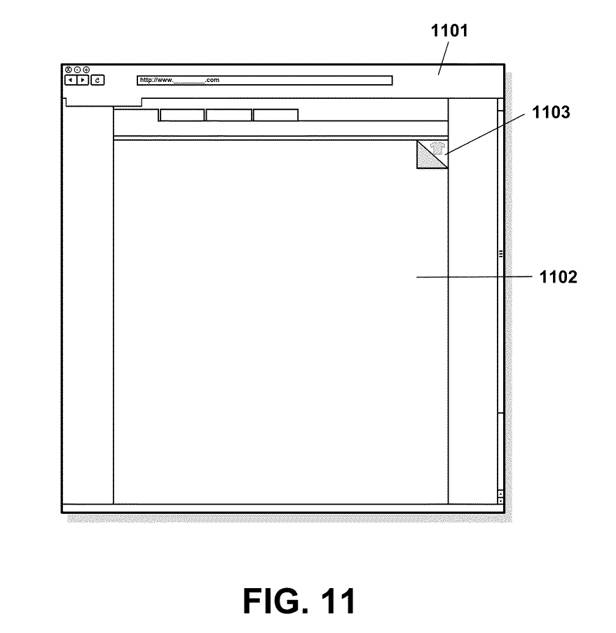

FIG. 11 shows the initial layout and look of the page peel ad placed on a web page according to various embodiments. The initial page peel ad is displayed in icon form. This page peel icon can be positioned in numerous locations and configuration on the web page. In this example the page peel icon is located on the top right hand corner of the web page. More specifically, an example web browser window 1101 is shown. The space 1102 on the web page that the page peel ad will be displayed is shown. The position of the page peel icon 1103 is also shown. It is placed in the top right hand corner of the web page. Other configurations may have the page peel icon in other areas.

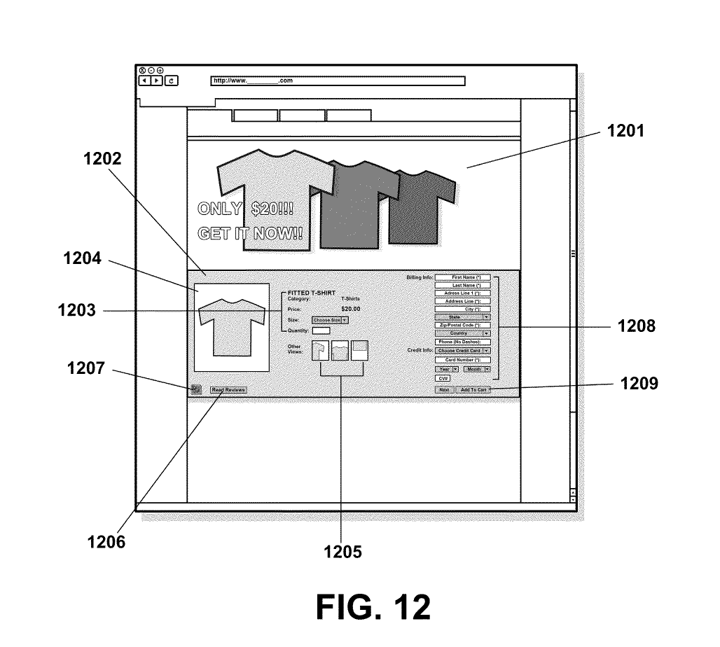

FIG. 12 shows the full layout of the page peel ad when it is activated and expanded according to various embodiments. This is the layout of the page peel ad after the user clicks on the page peel icon. Once the Icon is clicked, the page peel ad animation can be activated. The page peel icon can peel down and fold into the layout displayed in this example. The position of the peel on the web page can determine the manner in which the page peel ad animation lays out. The advertisement area 1201 of the page peel ad application is shown. This area can display the actual product being advertised in the page peel ad campaign. The advertisement can either be a static Image, animated image, or interactive image. A static image can load up as a plain image that the user does not interact with. The animated image is an ad that has animated movement in it. An interactive image is an ad that the user can click and interact with (e.g., an ad with clickable properties, an ad in the form of a web game, etc.).

The area 1202 of the page peel ad where the product being advertised can be sold is also shown. This area 1202 can display the web store for the specific product, full checkout system, and functional page peel ad tools. At 1203, the product information and product options tools that are part of the product web store are shown. The area of information can display elements such as: product's Name, product's category, product's base price, product options buttons (e.g., size, color, etc.), and quantity box. When the product information is modified from the market site, the information can automatically update the product information on the page peel ad. The product image 1204 that represents the product being sold from the web store is shown. When the product image 1204 is modified from the market site it can automatically update the product image in the page peel ad. Product views thumbnails 1205 are also shown. Clicking on one of the product views thumbnails 1205 will load the view into the product image area. When product views are modified from the market site it can automatically update the product views thumbnails on the page peel ad. Clicking the product review button 1206 can display the product reviews for this product. The product reviews can be generated directly from the market site. When a review is modified or created from the market site, it can be automatically updated on the page peel ad.

The page peel ad tools icon 1207 is shown. Clicking on this icon can open a window that allows the user to close the page peel ad or connect to a customer support representative using the live customers support chat feature. At 1208, the area that displays the checkout and payment system for the page peel ad is shown. Users are able to fill out their billing, shipping, contact, and credit information to make a secure purchase for the product being advertised. Once an order is placed, the order and transaction can be distributed. An example order and transaction distribution is shown at FIG. 3. The Add to Cart button 1209 allows the user to add the product to their universal shopping cart. If the user has a registered account with one of the multiple market sites, they may have the option to add the product to their universal shopping cart. As noted above, the product can remain in their shopping cart when they travel to other market sites or add products from other page peel ad hosted web pages.

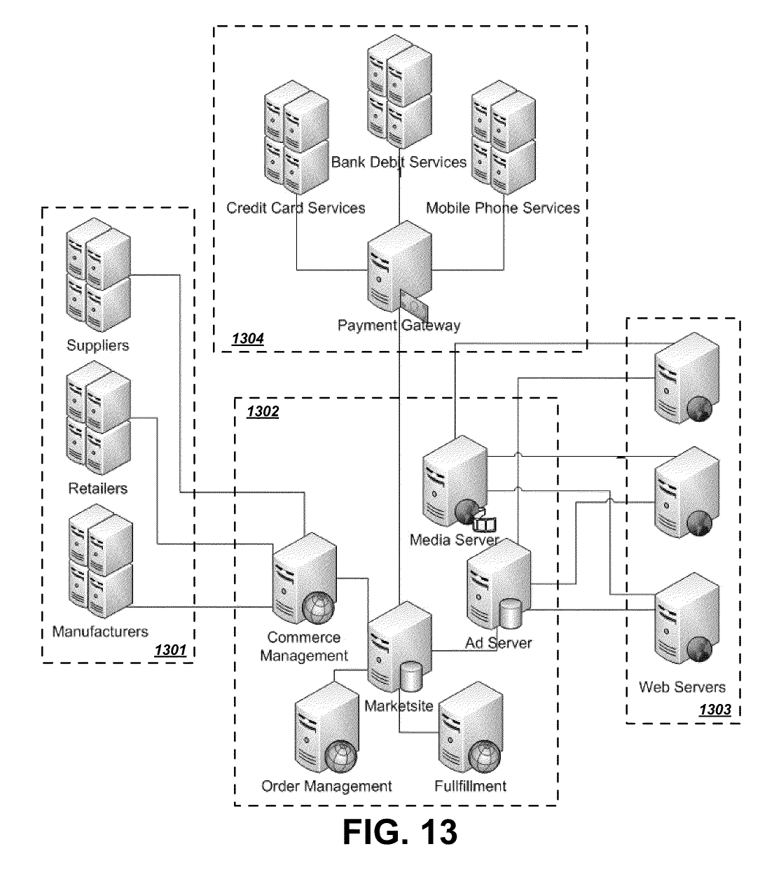

In FIG. 13, various system components that can be used to implement VSAs according to various embodiments are shown. As illustrated here, servers 1301 of various Suppliers, Retailers, and/or Manufacturers scan manage their published inventory via the Commerce Management server 1302. Once the inventory is known and the policies on where a VSA instance with inventory has been established with the Commerce Management server 1302, the VSA instances can be distributed to one or more web servers 1303 or other locations or devices, e.g., a phone, a smart phone, etc., remote from the Commerce Management server 1303. Any number of instances or a VSA can be distributed. Orders can flow back from the web servers 1303 or other remote devices to Commerce Management server 1302 to trigger order management processes. Orders can also possibly flow from Commerce Management server 1302 to the servers 1301 of the various Suppliers, Retailers, and/or Manufacturers if demand exceeds supply. Orders may also result in a purchase transaction where Commerce Management server 1302 communicates with servers and/or services of one or more payment networks 1304 to initiate a credit card transaction, a bank debit, or add the transaction to the mobile phone bill.

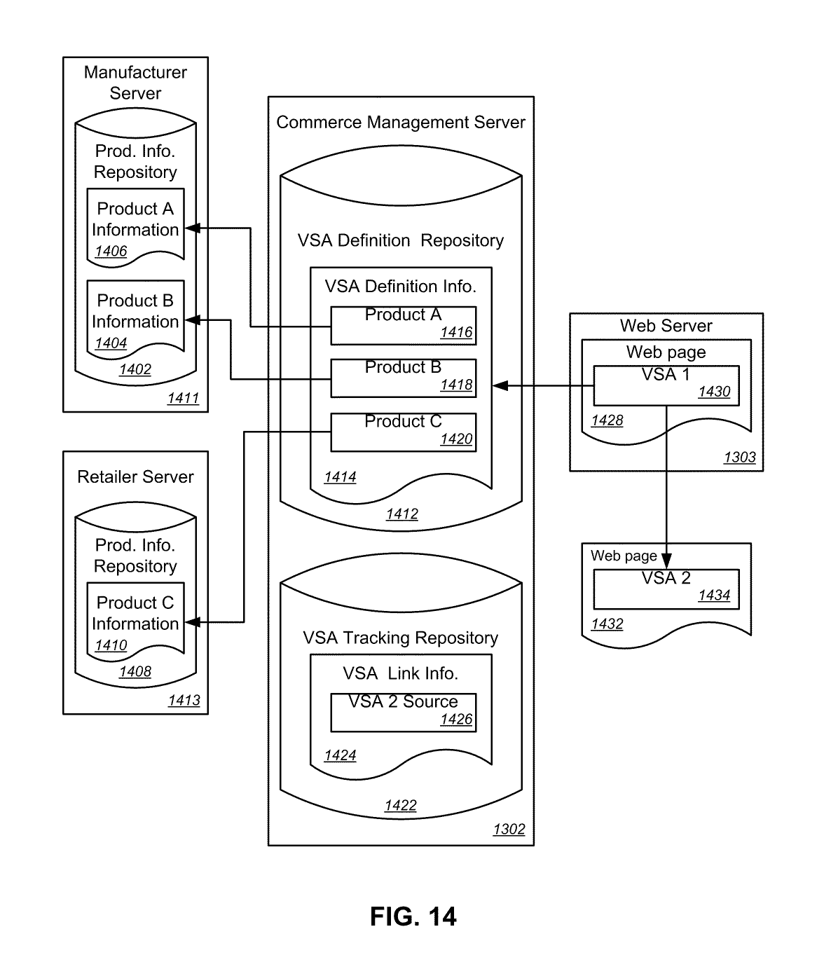

FIG. 14 is a block diagram illustrating additional details of system components for creating and tracking VSAs according to one embodiment of the present invention. This example illustrates a manufacturer server 1411 and a retailer server 1413 as introduced above. As noted, these servers, 1411 and 1413 can maintain repositories 1402 and 1408 of product information 1406, 1404, and 1410 including but not limited to inventory information, product descriptions, pricing information, etc.

Also illustrated here is commerce management server 1302 as introduced above. As noted, the commerce management server 1302 can receive a request to create a new VSA on a system remote from the commerce management server 1302 such as web server 1303. Based on this request, links 1416, 1418, and 1420 between the new VSA 1430 and product information 1406, 1404, and 1410 for each of one or more products stored on one or more servers remote from the commerce management server 1302, i.e., information from product information repositories 1402 and 1408 on servers 1411 and 1413, can be defined. The links 1416, 1418, and 1420 between the new VSA 1430 and the product information 1406, 1404, and 1410 can be stored, e.g., in VSA definition repository 1412 as a definition 1414 for the new VSA 1430. The new VSA 1430, including a link to the definition 1414 for the new VSA, can be inserted into a web page 1428 on the system 1303 remote from the commerce management server 1302.

In some cases as noted above, receiving the request to create the new VSA can comprise receiving a request to create multi-generational VSA, i.e., to copy the first VSA 1430 to a new VSA 1434 on a different web page 1432 or other location. In such cases, defining the links (not shown here for the sake of clarity and simplicity) between the new VSA 1434 and the product information can comprise identifying a source VSA, i.e., VSA 1430, for the new VSA 1432 and copying at least one link to product information from the identified source VSA, i.e., from links 1416, 1418, and 1420 of the VSA definition 1414 of the first VSA 1430, to a link or links in the definition information of the new VSA 1434 which can also be stored in VSA definition repository 1412.

The commerce management server 1302 can also track creation of the new VSA 1434. For example, tracking the creation of the new VSA 1434 can comprises determining or identifying the source VSA, i.e., VSA 1430, for the new VSA 1434. A link or relationship between the source VSA 1430 and the new VSA 1434 can be identified, e.g., a parent/child/grandchild etc relationship. A record 1424 of the link or relationship between the source VSA 1430 and the new VSA 1434 can then be stored in a tracking repository 1422. For example, VSA link information 1424 for the new VSA 1434 may include a record 1426 identifying the first VSA 1430 as a source or parent of the new VSA 1434. Based on the stored links or relationships between VSAs, a commerce management server 1302, a merchant, manufacturer, or retailer, or other system and/or entity may perform various analysis and/or provide various services. For example, such tracking or linking information may be useful in determining targeted marketing ads for users. Additionally or alternatively, the commerce management server may track and/or analyze purchases of products through or by related/linked VSAs. Additionally or alternatively, the systems may track and/or analyze views or accesses of product information by or through related/linked VSAs. Again, such information may be useful in analyzing the effectiveness of various marketing campaigns, designing and/or targeting new marketing ads or campaigns, etc.

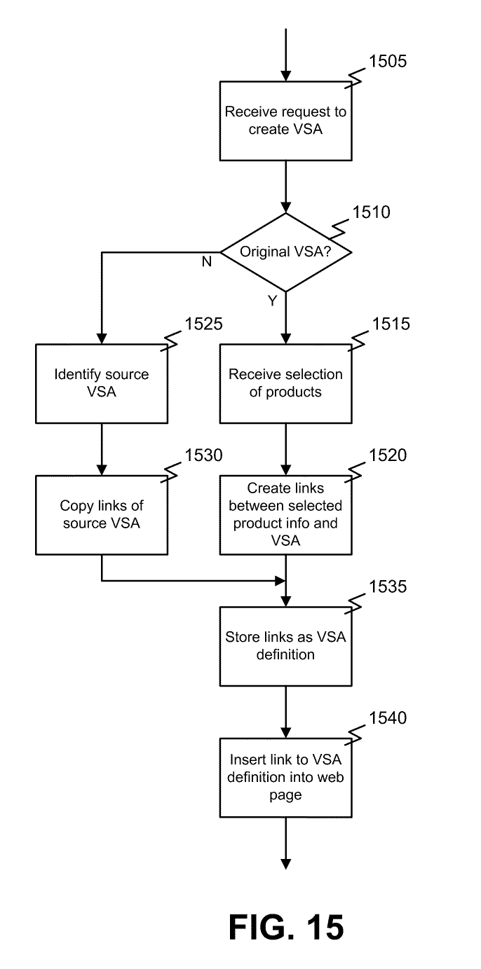

FIG. 15 is a flowchart illustrating an exemplary process for defining a VSA according to one embodiment of the present invention. In this example, processing begins with receiving 1505 a request at a commerce management server, the request to create a new VSA on a system remote from the commerce management server. Generally speaking, links between the new VSA and product information for each of one or more products stored on one or more servers remote from the commerce management server can be defined.

As noted above, in some cases, receiving 1505 the request to create the new VSA can comprise receiving a request to create a first generation VSA. Thus, a determination 1510 can be made as to whether the request is to create and original, i.e., first generation, VSA. In response to determining 1510 the request is to create a first generation VSA, defining the links between the new VSA and the product information can comprise receiving 1515 a selection of the one or more products and creating 1520 the links to the product information for the selected products.

Alternatively, receiving the request to create the new VSA can comprise receiving a request to create multi-generational VSA, e.g., to copy some or all of another VSA. In response to determining 1510 the request is to create a multi-generational VSA, defining the links between the new VSA and the product information can comprise identifying 1525 a source VSA for the new VSA and copying 1530 at least one link to product information from the identified source VSA to a link in the new VSA.

Once created 1520 or copied 1530, the links between the new VSA and the product information can be stored 1535 as a definition for the new VSA. A link to the definition for the new VSA can be inserted 1540 into a web page on the system remote from the commerce management server. For example, the web page on the system remote from the commerce management server can comprise a web page selected from a group consisting of, a social networking page, a blog page, personal web page. In some cases, inserting the link to the definition of the new VSA can comprise inserting a new element into the web page, the new element comprising an ad having a page peel effect for revealing the VSA.

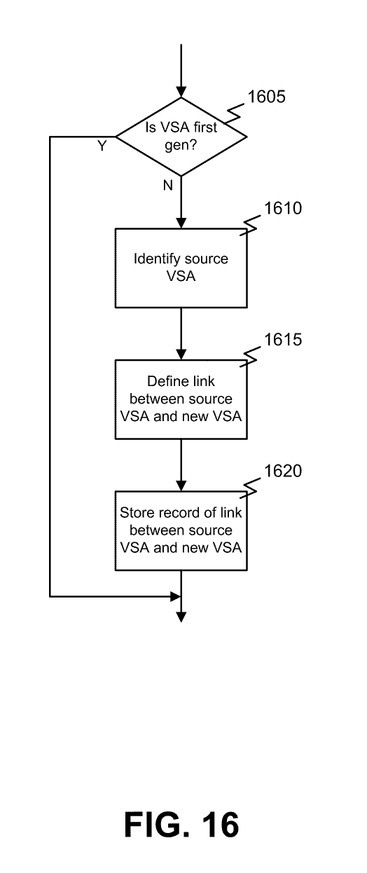

FIG. 16 is a flowchart illustrating an exemplary process for multi-generational tracking VSAs according to one embodiment of the present invention. In this example, tracking the creation of the new VSA can comprises determining 1605 whether the new VSA is a first generation VSA. In response to determining 1605 the new VSA is not a first generation VSA, e.g., the VSA is copied in whole or in part from one or more other VSAs, a source VSA for the new VSA can be identified 1610. A link or relationship between the source VSA and the new VSA can be identified 1615. A record of the link or relationship between the source VSA and the new VSA can then be stored 1620.

Based on the stored links or relationships between VSAs, a commerce management server as described herein, a merchant, manufacturer, or retailer, or other system and/or entity may perform various analysis and/or provide various services. For example, such tracking or linking information may be useful in determining targeted marketing ads for users. Additionally or alternatively, the commerce management server may track and/or analyze purchases of products through or by related/linked VSAs. Additionally or alternatively, the systems may track and/or analyze views or accesses of product information by or through related/linked VSAs. Again, such information may be useful in analyzing the effectiveness of various marketing campaigns, designing and/or targeting new marketing ads or campaigns, etc.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing a Viral Store Application (VSA), the method comprising:
receiving a request at a commerce management server, the request to create a new VSA on a system remote from the commerce management server;
defining with the commerce management server links between the new VSA and product information for each of one or more products stored on one or more servers remote from the commerce management server;
storing with the commerce management server the links between the new VSA and the product information as a definition for the new VSA; and
inserting with the commerce management server a link to the definition for the new VSA into a web page on the system remote from the commerce management server.

2. The method of claim 1, wherein receiving the request to create the new VSA comprises receiving a request to create a first generation VSA.

3. The method of claim 2, wherein defining the links between the new VSA and the product information comprises receiving a selection of the one or more products and creating the links to the product information for the selected products.

4. The method of claim 1, wherein receiving the request to create the new VSA comprises receiving a request to create multi-generational VSA.

5. The method of claim 4, wherein defining the links between the new VSA and the product information comprises identifying a source VSA for the new VSA and copying at least one link to product information from the identified source VSA to a link in the new VSA.

6. The method of claim 1, further comprising tracking creation of the new VSA.

7. The method of claim 6, wherein tracking the creation of the new VSA comprises:
determining with the commerce management server whether the new VSA is a first generation VSA; and
in response to determining the new VSA is not a first generation VSA, identifying with the commerce management server a source VSA for the new VSA, defining with the commerce management server a link between the source VSA and the new VSA, and storing with the commerce management server a record of the link between the source VSA and the new VSA.

8. The method of claim 1, wherein the web page on the system remote from the commerce management server comprises a web page selected from a group consisting of, a social networking page, a blog page, personal web page.

9. The method of claim 1, wherein inserting the link to the definition of the new VSA comprises inserting a new element into the web page, the new element comprising an ad having a page peel effect for revealing the VSA.

10. A commerce management server system comprising:
a processor; and
a memory communicatively coupled with and readable by the processor and having stored therein a series of instructions which, when executed by the processor, cause the processor to provide a Viral Store Application (VSA) by receiving a request to create a new VSA on a system remote from the commerce management server, defining links between the new VSA and product information for each of one or more products stored on one or more servers remote from the commerce management server, storing the links between the new VSA and the product information as a definition for the new VSA, and inserting a link to the definition for the new VSA into a web page on the system remote from the commerce management server.

11. The commerce management server system of claim 10, wherein receiving the request to create the new VSA comprises receiving a request to create a first generation VSA.

12. The commerce management server system of claim 11, wherein defining the links between the new VSA and the product information comprises receiving a selection of the one or more products and creating the links to the product information for the selected products.

13. The commerce management server system of claim 10, wherein receiving the request to create the new VSA comprises receiving a request to create multi-generational VSA.

14. The commerce management server system of claim 13, wherein defining the links between the new VSA and the product information comprises identifying a source VSA for the new VSA and copying at least one link to product information from the identified source VSA to a link in the new VSA.

15. The commerce management server system of claim 10, further comprising tracking creation of the new VSA.

16. The commerce management server system of claim 15, wherein tracking the creation of the new VSA comprises:
determining whether the new VSA is a first generation VSA; and
in response to determining the new VSA is not a first generation VSA, identifying a source VSA for the new VSA, defining a link between the source VSA and the new VSA, and storing a record of the link between the source VSA and the new VSA.

17. A machine-readable medium having stored thereon a series of instructions which, when executed by a processor, cause the processor to for providing a Viral Store Application (VSA) by
receiving a request to create a new VSA on a remote system;
defining links between the new VSA and product information for each of one or more products stored on one or more remote servers;
storing the links between the new VSA and the product information as a definition for the new VSA; and
inserting a link to the definition for the new VSA into a web page on the remote system.

18. The machine-readable medium of claim 17, wherein receiving the request to create the new VSA comprises receiving a request to create a first generation VSA.

19. The machine-readable medium of claim 18, wherein defining the links between the new VSA and the product information comprises receiving a selection of the one or more products and creating the links to the product information for the selected products.

20. The machine-readable medium of claim 17, wherein receiving the request to create the new VSA comprises receiving a request to create multi-generational VSA.

21. The machine-readable medium of claim 20, wherein defining the links between the new VSA and the product information comprises identifying a source VSA for the new VSA and copying at least one link to product information from the identified source VSA to a link in the new VSA.

22. The machine-readable medium of claim 17, further comprising tracking creation of the new VSA.

23. The machine-readable medium of claim 22, wherein tracking the creation of the new VSA comprises:
determining whether the new VSA is a first generation VSA; and
in response to determining the new VSA is not a first generation VSA, identifying a source VSA for the new VSA, defining a link between the source VSA and the new VSA, and storing a record of the link between the source VSA and the new VSA.
